(19) United States
(12) Patent Application Publication
(10) Pub. No.: US 2013/0039845 A1
(43) Pub. Date: Feb. 14, 2013

(54) Method For Producing Hydrogen

(71) Applicants: Michael R. Detty, Rochester, NY (US); Brandon D. Calitree, Amherst, NY (US); Alexandra Orchard, Tonawanda, NY (US); Richard Eisenberg, Rochester, NY (US); Theresa McCormick, Toronto (CA)

(72) Inventors: Michael R. Detty, Rochester, NY (US); Brandon D. Calitree, Amherst, NY (US); Alexandra Orchard, Tonawanda, NY (US); Richard Eisenberg, Rochester, NY (US); Theresa McCormick, Toronto (CA)

(21) Appl. No.: 13/522,832

(22) PCT Filed: Jan. 19, 2011
(86) PCT No.: PCT/US11/21647

§ 371 Date: Oct. 16, 2012

Related U.S. Application Data
(60) Provisional application No. 61/296,224, filed on Jan. 19, 2010.

(51) Int. Cl. C01B 3/06

(52) U.S. Cl. 423/657

(57) ABSTRACT

A method for production of hydrogen. In the method, an aqueous solution of a chalcogenoxanthylium compound, a catalyst and sacrificial electron donor are exposed to electromagnetic radiation with a wavelength of from 400 nm to 850 nm. Exposure of the aqueous solution to the electromagnetic radiation results in production of hydrogen. Such a method can be used, for example, in dye-sensitized solar cell.

### CROSS-REFERENCE TO RELATED APPLICATIONS

This application claims priority to U.S. provisional patent application No. 61/296,224, filed Jan. 19, 2009, the disclosure of which is incorporated herein by reference.

### STATEMENT REGARDING FEDERALLY SPONSORED RESEARCH

This invention was made with government support under contract no. N00014-09-1-0217 awarded by the Office of Naval Research. The government has certain rights in the invention.

### FIELD OF THE INVENTION

The present invention generally relates to compounds and methods for producing hydrogen. More particularly, the present invention relates to use of the compounds disclosed herein in methods for producing hydrogen.

### BACKGROUND OF THE INVENTION

Fujishima and Honda first reported the photocatalytic decomposition of water by platinized TiO₂ powders in the early 1970s. While their work demonstrated the potential of TiO₂-based photocatalysts for splitting water, quantum yields were limited by inefficient absorption of visible light by TiO₂. Dye-sensitization represents a promising strategy to red-shift the absorption onset of TiO₂-based reductive photocatalysts and has led to the development of dye-sensitized photocatalysts (DSPs). A typical hydrogen-evolution mechanism of DSPs (FIG. 1) involves electron injection from the photoexcited sensitizer into TiO₂ followed by electron transport to Pt, which catalyzes the reduction of protons. The sensitizer is re-reduced by a sacrificial electron donor (SeD). Recombination of the injected electron with the oxidized dye competes with proton reduction and oxidation of the sacrificial donor. Organic sensitizers (eosin Y, merocyanines, coumarins) and inorganic sensitizer (Ru(II) and Pt(II) polypyridyl complexes) have been explored as light-harvesters for DSPs. Quantum efficiencies of 10-12% and turnover numbers approaching 10⁴ have been reported for hydrogen evolution from aqueous media; however, long-term photostability remains an issue. The photocatalytic efficiency depends on the surface-binding mode of the sensitizer, the identity of the sacrificial donor, pH, and the composition of mixed solvent systems. Despite modest success in the past, and the understanding of the deficiencies in this field, there is still a need for efficient and stable photocatalytic compounds for the evolution of hydrogen from aqueous media.

### BRIEF SUMMARY OF THE INVENTION

The present invention provides a method for generating hydrogen comprising the steps of: a) providing an aqueous solution comprising a catalyst, a sacrificial electron donor and a compound having the structure of Formula I:

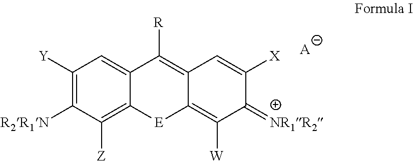

and, b) exposing the solution from step a) to electromagnetic radiation having a wavelength of from 400 nm to 850 nm, such that hydrogen is generated.

The aqueous solution has from 10 mol % to 100 mol % water and can, optionally, contain a miscible solvent. In an embodiment, the pH of the solution is from 2 to 10.

In an embodiment, the sacrificial electron donor is triethanolamine (TEOA). In an embodiment, the homogeneous catalyst is Co(dmgH)₂Cl(py). In another embodiment, the heterogeneous catalyst is semiconducting metal oxide nanoparticles, where the particles have a metal or metal alloy deposited on the surface of the particles. For example, the semiconducting metal oxide nanoparticles are titania or zirconia and the metal is platinum, where the nanoparticles have from 0.02 to 2 wt-% metal. In another emobodiment, the heterogeneous catalyst is a colloidal metal selected from palladium or platinum, where the amount of catalyst is from 0.001 mg/mL to 0.1 mg/mL.

In an embodiment, the electromagnetic radiation has a wavelength of from 400 nm to 850 nm. In various embodiments, the source of electromagnetic radiation is a mercury xenon lamp, a light emitting diode, a laser and sunlight.

### BRIEF DESCRIPTION OF THE FIGURES

FIG. 1. Cartoon depicting hydrogen generation by a dye-sensitized photocatalyst (DSP) on TiO₂. A sacrificial electron donor is abbreviated as SeD.

FIG. 2. Examples of chalcogenoxanthylium dyes as photocatalysts for hydrogen evolution.

FIG. 3. Examples of turnover numbers (TON) for dyes 3b, 3c, 7b, and 7c as photosensitizers for evolution of hydrogen with Pt/TiO₂ and Co(dmgH)₂Cl(py).

FIG. 4. Structures of a) photosensitizers 1-3 and b) [Co^{III}(dmgH)₂(py)Cl] 4 (where dmgH=dimethylglyoximate , py=pyridine).

FIG. 5. Example of hydrogen generation in 5% TEOA in 1:1 CH₃CN:H₂O, pH 7 irradiated with 520 nm LED): (a) effect of varying [2] in a system containing 2.0×10⁻⁴ M 4; (b) effect varying [4] with 2.0×10⁻⁵ M 2.

FIG. 6. Scheme I. Example of a reaction scheme for H₂ photogeneration

FIG. 7. Examples of chalcogenoxanthylium dyes as photocatalysts for hydrogen evolution.

FIG. 8. Example of luminescence of singlet oxygen sensitized with a) photosensitizer 3, b) photosensitizer 2, and c) photosensitizer 1, with excitation at 532 nm in MeOH solutions. Gaussian fits are shown for every band. Concentrations of all solutions were adjusted to give optical density (OD)=0.4 at 532 nm.

FIG. 9. Example of electronic a) absorbance and b) emission spectra of 1 and Rhodamine 6G (R6G; 9-[2-(ethoxycarbonyl)phenyl]-3,6-bis(ethylamino)-2,7-dimethyl-xanthylium) at various concentrations in MeOH.

FIG. 10. Example of comparison of the area of the emission peak as a function of absorbance for 1 and R6G.

FIG. 11. Example of recovered values of fluorescence quantum yield (Φ_{FL}) and fluorescence lifetime (τ_{FL}) for 1.

FIG. 12. Examples of electronic a) absorbance and b) emission spectra of 2 and sulforhodamine 101 (CAS No. [82354-19-6]) at various concentrations in MeOH.

FIG. 13. Example of comparison of the area of the emission peak as a function of absorbance for 2 and sulforhodamine 101.

FIG. 14. Examples of recovered values of fluorescence quantum yield (Φ_{FL}) and fluorescence lifetime (τ_{FL}) for 2.

FIG. 15. Examples of electronic a) absorbance and a) emission spectra of 3 and sulforhodamine 101 at various concentrations in MeOH.

FIG. 16. Example comparing the area of the emission peak as a function of absorbance for 3 and sulforhodamine 101.

FIG. 17. Example of recovered values of fluorescence quantum yield (Φ_{FL}) and fluorescence lifetime (τ_{FL}) for 3.

FIG. 18. Example of 5×10⁻⁶ M solution of 3 in 1:1 CH₃CN:H₂O with the addition of molar equivalents of a) TEOA or b) 4, emission with excitation at 580 nm.

FIG. 19. Example of a) hydrogen generation from 8.2×10^{-b} M 2 2×10⁻⁴ M 4, and b) initial rate of hydrogen generation, with varying concentrations of TEOA in 1:1 CH₃CN:H₂O, pH 7 irradiated with 520 nm LEDs.

FIG. 20. Example of hydrogen generation from 8.2×10⁻⁶ M 2 and stated concentrations of 4, with the addition of dmgH₂. 5% TEOA in 1:1 CH₃CN:H₂O, pH 7 irradiated with 520 nm LEDs.

FIG. 21. Example of rate of H₂ generation taken from the slope of the line of mL of H₂ over time for the first 30 min of H₂ production at 8.2×10⁻⁶ M 2 and 5% TEOA in 1:1 CH₃CN:H₂O, pH 7 irradiated with 520 nm LEDs over a range of concentrations of 4.

FIG. 22. Example of UV-Vis spectrum of 5×10⁻⁷ M 3 and 1.2×10⁻⁴ M 4 in 5% TEOA in 1:1 CH₃CN:H₂O, pH 7 irradiated with 455 cut off filter.

FIG. 23. Example of hydrogen generation a) effect of concentration of 3 in a system containing 4×10⁻⁵ M 4; b) effect of concentration of 4 with 1.9×10⁻⁵ M 3. Both contain 5% TEOA in 1:1 CH₃CN:H₂O, pH 7 irradiated with 520 nm LEDs.

FIG. 24. Example of effect of concentration of 4 on hydrogen generation in a system containing 1.2×10⁻⁵ M 2 and 5% TEOA in 1:1 CH₃CN:H₂O at pH 7 irradiated with 520 nm LEDs. At high concentrations of 4 there is an induction period and slowed rate of hydrogen production.

FIG. 25. Example of hydrogen generation from 5×10⁻⁶ M 3, 3.7×10⁻⁴ M 4, pH 7, 5% TEOA solution in 1:1 CH₃CN:H₂O, irradiated with 455 nm cutoff filter. Every 15 minutes for the first 180 minutes 0.25 mL (3 molar equivalents to 4) of 1.7×10⁻² M of dmgH₂ in 1:1 CH₃CN:H₂O was added. Addition of the dmgH₂ increases system longevity and overall H₂ production.

FIG. 26. Example of hydrogen generation from 5×10⁻⁶ M 2 2.5×10⁻⁴ M 4, with varying the pH of the 5% TEOA solution in 1:1 CH₃CN:H₂O, irradiated with 455 nm cutoff filter.

FIG. 27. Example of hydrogen generation from 5×10⁻⁶ M 2 and 3, varying 4, pH 7, 5% TEOA solution in 1:1 CH₃CN:H₂O, irradiated with 455 nm cutoff filter. 2 shows a longer induction period for the same concentration of 4 and a slower TOF (turnover frequency).

FIG. 28. Chemical structure of examples of photosensitizers used for hydrogen evolution.

FIG. 29. Example of a synthetic scheme for preparation of compounds of the present invention.

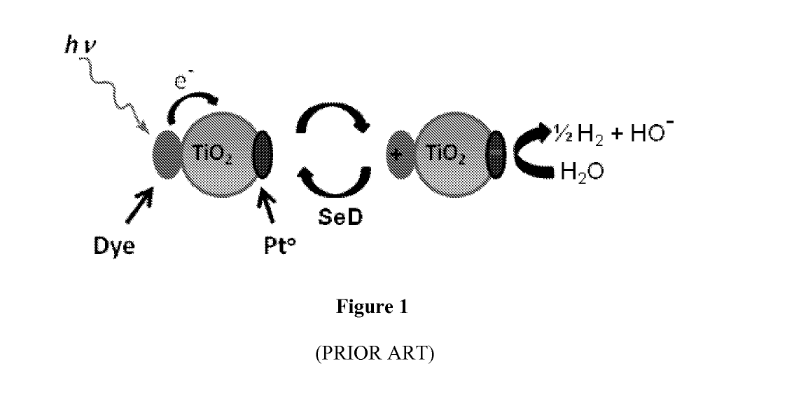

### DETAILED DESCRIPTION OF THE INVENTION

The present invention provides a method for producing hydrogen. In various embodiments, the compounds disclosed herein are used in a method for production of hydrogen.

The present invention is based on the surprising finding that chalcogenoxanthylium dyes (e.g., 3,6-diaminochalcogenoxanthylium chromophores) are photosensitizers for both heterogeneous (e.g., Pt—TiO₂) systems and homogeneous (e.g., Co(dmgH)₂Cl(py)) systems and give greater hydrogen evolution than that observed with other organic chromophores including eosin.

The method of the present invention comprises the steps of: a) providing an aqueous solution comprising a compound having the structure of Formula I (described below), a catalyst (e.g., a homogeneous catalyst and/or heterogeneous catalyst) and a sacrificial electron donor; and b) exposing the solution from step a) to electromagnetic radiation having a wavelength of from 400 nm to 850 nm, such that hydrogen is generated.

The aqueous solution has from 10% to 100% water on a mole basis. The aqueous solution can, optionally, include a miscible solvent. Examples of miscible solvents include, but are not limited to, acetonitrile, dioxolane, tetrahydrofuran and the like.

Various xanthylium compounds, and S, Se and Te derivatives thereof, can be used in the present invention. Examples of suitable compounds are described in U.S. patent application Ser. No. 11/195,393, filed Aug. 2, 2005, titled “NOVEL CHALCOGENOXANTHYLIUM DYES FOR PURGING BLOOD PATHOGENS AND FOR PHOTODYNAMIC THERAPY”, and all disclosure related to the compounds and methods of making the compounds in this patent application is incorporated herein by reference. Without intending to be bound by any particular theory it is considered that in the homogeneously catalyzed system the compound acts as a photosensitizer by absorbing electromagnetic radiation resulting in formation of a triplet excited state which then transfers an electron to the catalyst.

The compounds of the present invention e.g., chalcogenoxanthylium compounds, can be prepared, for example, by the directed-metallation/cyclization of the corresponding N,N-diethyl 2-(3-dimethylaminophenylchalcogeno)-4-dimethylaminobenzamide to the 2,7-bis-(N,N-dimethylamino)-9H-chalcogenoxanthen-9-one followed by the addition of the appropriate magnesium bromide reagent (e.g., phenylmagnesium bromide), dehydration and ion exchange to the chloride salt.

A general method for the preparation of the compounds disclosed above is outlined below, and comprises the following steps:

Step 1. Providing a compound (1) of the following structure:

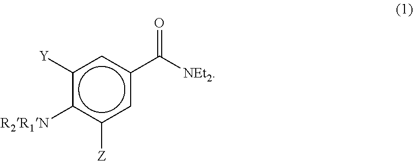

I)
   i) Y and Z are hydrogen;
   ii) R₁′ and R₂′ are, independently, hydrogen or C₁ through C₈ branched or unbranched alkyl groups and, optionally, R₁′ and R₂′ are alkyl groups connected such that they comprise a three, four, five, six or seven-membered ring:

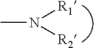

which, if desired, can bear substituents such as, for example, alkyl or aryl groups; or
II)
   i) Y and Z are independently hydrogen or C₁ through C₈ alkyl and R₁′ and R₂′ are independently hydrogen or C₁ through C₈ alkyl;
wherein R₁′ and Y are, optionally, connected such that they comprise a five, six or seven-membered ring:

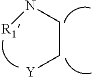

and/or R₂′ and Z are connected such that they comprise a five-, six- or seven-membered ring:

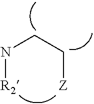

Compounds of the above structure (1) can be obtained commercially or prepared from appropriately substituted carboxylic acid derivatives by first forming the corresponding acid chloride with oxallyl chloride or thionyl chloride and then treating with diethylamine. It is not essential that the substituents on the amide nitrogen be ethyl groups, and other alkyl groups, such as branched and unbranched alkyl groups, such as those comprising eight or fewer carbons can be used instead of ethyl groups.

Step 2. Forming a reaction mixture comprising compound (1), N,N,N,N-tetramethylethylenediamine (TMEDA), sec- or tent-butyl lithium and a solvent whereby said compound (1) is lithiated at the 2 position. The reaction mixture is generally formed by first combining compound (1) with TMEDA in a solvent, followed by the addition of the butyl lithium component. The butyl lithium component is preferably added in a controlled manner, such as by dropwise addition to the solution containing the other reactants. A range of solvents can be used, including, for example, such common solvents as tetrahydrofuran (THF), ether, and dimethoxyethane. THF is preferred.

Step 3. Adding a compound (2) of the following structure:

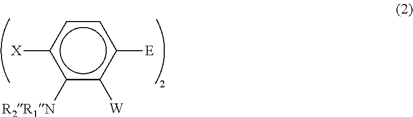

to the reaction mixture such that a compound (3), having the following structure is formed:

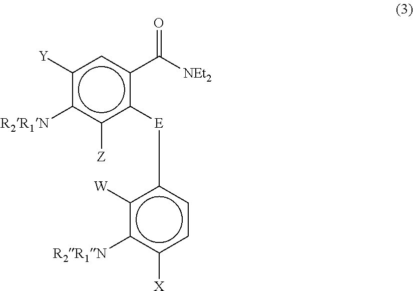

wherein E is O, S, Se or Te, and
I)
   i) W and X are hydrogen;
   ii) R₁″ and R₂″ are independently hydrogen, C₁ through C₈ branched or unbranched alkyl and, optionally, R₁″ and R₂″ are alkyl groups connected such that they comprise a three, four, five, six or seven-membered ring:

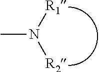

which, if desired, can bear substituents such as alkyl or aryl groups; or
II)
   i) W and X are independently hydrogen or C₁ through C₈ alkyl;
   ii) R₁″ and/or R₂″ are independently hydrogen or C₁ through C₈ alkyl;
and wherein R₁″ and W are connected such that they comprise a five, six or seven-membered ring:

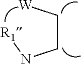

and/or wherein R₂″ and X are connected such that they comprise a five-, six- or seven-membered ring:

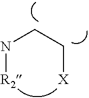

As with R′₁ and R′₂, R″₁ and R″₂ are independently hydrogen or straight or branched alkyl groups, preferably having 8 or fewer carbon atoms.

Compound (2), referred to herein as a “dichalcogenide” compound, can be prepared by the use of a 3-Bromoaniline (optionally N-substituted with one or two alkyl groups, branched or straight, each having 8 or fewer carbons), magnesium, and elemental sulfur or selenium, such as sulfur powder, selenium metal, whole or crushed selenium shot, selenium shavings, etc., to form a 3-chalcogenolated aniline compound. The bromoaniline compound and magnesium are first reacted to form a Grignard reagent. The Grignard reagent is then reacted with the elemental sulfur or selenium. Preferably, the 3-bromoaniline compound, the magnesium and a solvent are combined and refluxed for a time, preferably in the range of 0.5 hour to 4 hours, after which the mixture is cooled, preferably to room temperature. Elemental sulfur or selenium is then added to the solution containing the Grignard reagent. The mixture is again refluxed for a time in the range of from 0.5 h to 4 h, and cooled, preferably to about room temperature or below, such as by allowing it to stand for a time. It is then diluted with water and cooled further, both of which can be accomplished simultaneously by pouring the mixture over ice. An acid such as HCl is added to the mixture to give a 3-chalcogenolated compound, after which the 3-chalcogenolated compound is oxidized to the dichalcogenide compound. The oxidation is preferably accomplished by contacting the dichalcogenolated compound with a mild oxidant such as air or an alkylated or arylated selenoxide or telluroxide, such as dihexyl telluroxide. It is preferred to maintain a temperature in the range of 0 to −100 ° C. during the addition of the butyl lithium and the dichalcogenide.

The dichalcogenide compound is added to the reaction mixture, preferably in a controlled manner, such as by dropwise addition while dissolved in a suitable solvent, such as THF. It is preferred that the dichalcogenide be added after the butyl lithium. It is also preferred to reflux for a time greater than 0.5 h after the addition of the butyl lithium compound and before dichalcogenide addition.

Step 4. Contacting said compound (3) with lithium diisopropylamide (LDA) to form a compound (4) of the following structure:

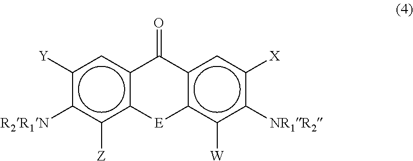

Step 5. Compound (3) is contacted with LDA, preferably by dissolving compound (3) in a solvent to form a first solution, and adding LDA, preferably solvated as a second solution, and stirring the combined for a time in the range of 0.1 to 2 hours, followed by quenching with a quencher, preferably a saturated ammonium chloride solution. Converting compound (4) to a compound (5) of the following structure:

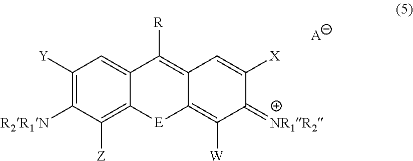

wherein R is an alkyl group of 1 carbon to 8 carbons, aryl, substituted aryl, heteroaryl, or substituted heteroaryl group and E is O, S, Se or Te. The aryl group may be mono-, di-, or tri-substituted with substituents at the ortho, meta, or para positions. Useful substituents include, but are not limited to, —CO₂Me, —CO₂H, —NMe₂ and other dialkylamino (each alkyl group independently having 8 or fewer carbons), —NHEt and other alkylamino (of 1 carbon to 8 carbons), —NH₂, -Me and other alkyl (of 1 carbon to 8 carbons), —OMe and other alkoxy (of 1 carbon to 8 carbons), various heterocyclic groups such as, for example, 1,3-oxazole, 1,3-diazole, 4,5-dihydro-1,3-oxazole and 4,5-dihydro-1,3-thiazole, and phosphonate (—P(OH₂)═O).

A⁻ is an anionic group such as Cl⁻ or other halides, tosylate or other sulfonates, acetate or other carboxylates, hexafluorophosphate, tetrafluoroborate, perchlorate and the like.

It may be convenient to sequentially perform two or more of the preceding steps in the “same pot.” However, it is preferred that resulting compounds (1), (2), (3) and (4) be purified to some degree before their use in a subsequent step, which may be accomplished by methods known in the art.

The preferred method of conversion of a compound (4) to compound (5) depends upon the R group desired in the end product. However, the conversion can generally be accomplished by methods including the use of Grignard-type reagents or organolithium reagents. For example alkyl magnesium bromides and/or alkyl lithiums and phenyl magnesium bromides and/or aryl lithiums can be used to add an alkyl or a phenyl group, respectively, at the ketone carbon chain of compound (4). Substituted aryl groups or heteroaryl groups can also be added by the use of Grignard-type reagents in appropriate solvents. As is well known in the art, the treatment of a ketone compound with either a Grignard reagent or an organolithium reagent, followed by acidification of the solution results in the formation of an alcohol compound. In order to prepare a chalcogenoxanthylium compound of Formula I, it is necessary to convert the alcohol to a chalcogenoxanthylium salt. Counter anions include halides, such as, for example, Cl⁻; sulfonates such as, for example, tosylate; carboxylates, such as, for example acetate; hexafluorophosphate; tetrafluoroborate; and the like. Salt formation can be accomplished by the addition of the acid of the desired counter anion. For example, the addition of hydrochloric acid or hexafluorophosphoric acid to the solution following Grignard treatment will give the chloride and hexafluorophosphate salts, respectively. The acid is preferably added to the solution in a controlled manner, such as, for example, dropwise addition. The chalcogenoxanthylium chloride or hexafluorophosphate salt can be precipitated from the solution by cooling the solution to a temperature in the range of −50° C. to 0° C.

Further changing of the anion identity, such as conversion of hexafluorophosphate salt to a chloride salt can be accomplished by methods known in the art, such as, for example, ion exchange resins and the like. The foregoing method is illustrated in FIG. 29.

In various embodiments, the compounds than can be used in the method are depicted in Formula I below.

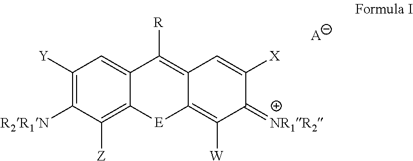

In various other embodiments, the compounds are depicted in the following formulas:

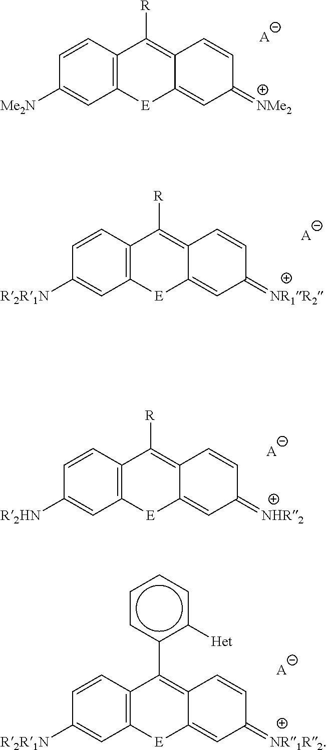

In various other embodiments, the compounds are depicted in the following formulas:

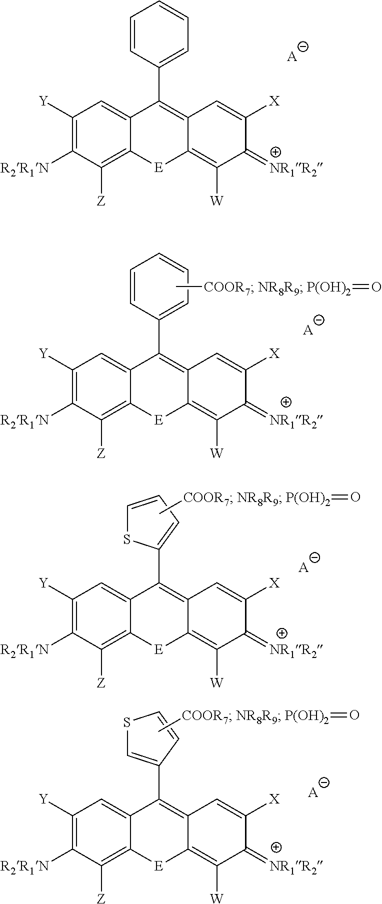

In the above embodiments, the W, X, Y and Z substituents are, independently, hydrogen or alkyl group having 1 carbon to 8 carbons (including all integers therebetween). The term “alkyl group” as used herein means a saturated hydrocarbon that can be linear or branched and substituted or unsubstituted. R is an alkyl group of 1 carbon to 8 carbons (including all integers therebetween), aryl, substituted aryl, heteroaryl, substituted heteroaryl, heterocyclic, or substituted heterocyclic group and E is O, S, Se or Te. The aryl group has from 5 carbons to 8 carbons (including all integers therebetween), and may be mono-, di-, or tri-substituted with, for example, substituents at the ortho, meta, or para positions. Useful substituents include, but are not limited to, —CO₂Me, —CO₂H, —NMe₂ and other dialkylamino (having 1 carbon to 8 carbons, including all integers therebetween), —NHEt and other alkylamino (having 1 carbon to 8 carbons, including all integers therebetween), —NH₂, -Me and other alkyl (having 1 carbon to 8 carbons, including all integers therebetween), —OMe and other alkoxy (having 1 carbon to 8 carbons, including all integers therebetween), various heterocyclic groups (Het) such as, but not limited to, 1,3-oxazole, 1,3-diazole, 4,5-dihydro-1,3-oxazole, 4,5-dihydro-1,3-thiazole and the like, and phosphonate (—P(OH)₂═O).

The substitution on the aryl ring may also be a ring structure providing compounds having the following formula:

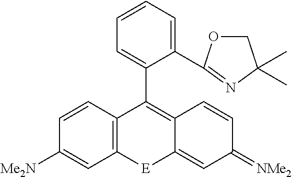

The amino substituents, —NR′₁R′₂ and —NR″₁R″₂, at the 2- and 7-positions of the chalcogenoxanthylium core may be the same or different and may be selected from dimethylamino or other dialkylamino where the alkyl group(s) have 1 carbon to 8 carbons, including all integers therebetween, ethylamino or other alkylamino from 1 carbon to 8 carbons, including all integers therebetween, or may be unsubstituted amino. The alkyl groups of the —NHR′₂, NHR″₂, —NR′₁R′₂ or —NR″₁R″₂ groups may form 5, 6, or 7-membered rings back to the chalcogenoxanthylium core, for example, as illustrated for:

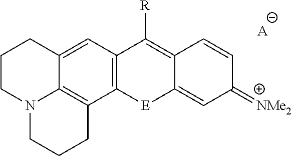

The alkyl groups of —NHR′₂, NHR″₂, —NR′₁R′₂ or —NR″₁R″₂ may also be substituted with one or more carboxylic acid group(s) and/or phosphonate group(s). The following is an example of such an alkyl group. In this example, R is hydrogen or another alkyl group as described herein and n can be from 1 to 8, including all integers therebetween.

—NR(—CH₂)ₙ—COOH

The compound can, optionally, bear W, X, Y and Z substituents which, independently, join the nitrogen substituents such that a single or double ring structure is formed on either or both end rings of the molecule. The rings that comprise the nitrogen substituents and substituents W, X, Y and Z may be, for example, 5, 6 or 7 member rings. The structure below illustrates a compound having a two ring structure on one xanthylium end ring of the compound.

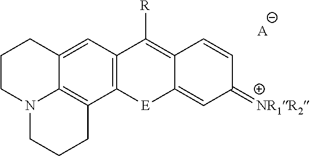

A is an anionic group selected from Cl and other halide, tosylate and other sulfonate, acetate and other carboxylates, hexafluorophosphate, tetrafluoroborate, perchlorate, and the like.

In one embodiment, the compound has the structure of Figure I above and W, X, Y, and Z are hydrogen. R₁′, R₂′, R₁″ and R₂″ are independently hydrogen or C₁ to C₈ alkyl group. Optionally, R₁′ and R₂′ and/or R₁″ and R₂″ are alkyl groups connected such that they form a 3-, 4-, 5-, 6- or 7-membered ring (shown in the following structures)

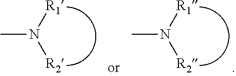

R is hydrogen or a C₁ through C₈ alkyl, including all integers therebetween, aryl, heteroaryl, substituted aryl or substituted heteroaryl group or

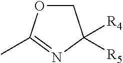

where R₄ and R₅ are C₁ through C₈ alkyl groups, including all integers therebetween. In an embodiment, it E is Se, R is not hydrogen.

In another embodiment, the compound has the structure of Figure I above and W, X, Y and Z are independently hydrogen or C₁ to C₈ alkyl group (including all integers therebetween). R₁′, R₂′, R₁″ and R₂″ are independently hydrogen or C₁ through C₈ alkyl group (including all integers therebetween). Optionally, R₁′ and Y are connected such that they form a five, six or seven-membered ring (as shown in the following structure)

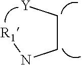

and/or R₂′ and Z are connected such that they comprise a five-, six- or seven-membered ring (as shown in the following structure)

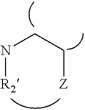

and/or R₁″ and W are connected such that they form a five-, six- or seven-membered ring

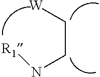

and/or R₂^{″} and X are connected such that they form a five-, six- or seven-membered ring:

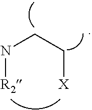

R is a C₁ to C₈ alkyl group (including all integers therebetween), aryl, substituted aryl, heterocyclic or substituted heterocyclic group.

Examples of compounds useful in the present invention are depicted below.

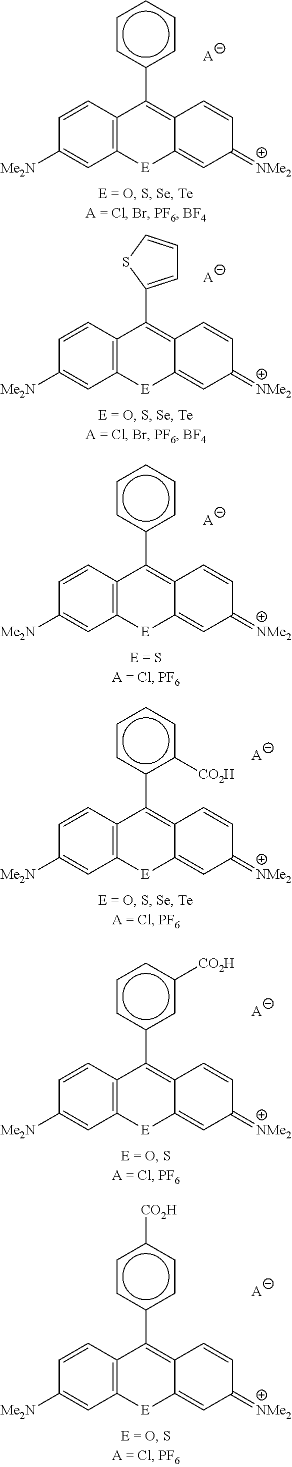

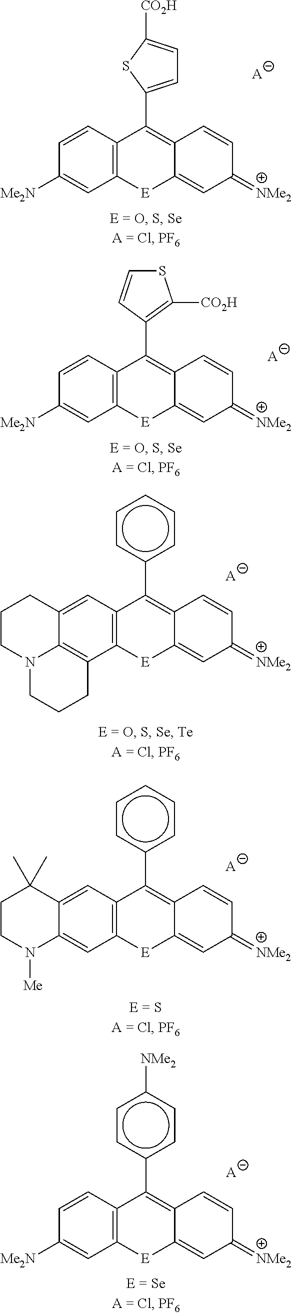

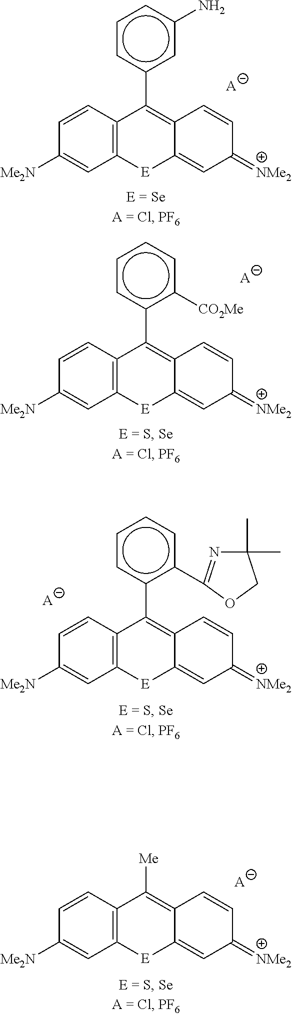

The catalyst (e.g., homogeneous catalyst and heterogeneous catalyst) is any material which catalyzes formation of hydrogen from water. A homogeneous catalyst is any metal compound soluble in the aqueous solution that can undergo reductive elimination of hydrogen following electron transfer from photoexcited catalyst complex to the metal compound. Examples of suitable homogenous catalysts include, but are not limited to, Co(dmgH)₂Cl(py) (where dmgH is a dimethylglyoxime derivative and py is pyridine) and the like.

A heterogeneous catalyst is not soluble in the aqueous solution and is any metal or metal alloy that on accepting an electron or electrons can reduce protons to form water. In one embodiment, the metal or metal alloy is deposited on a semiconducting metal oxide that acts as relay from photoexcited compound. The compound can chemically interact (e.g., form a chemical bond) to the surface of the semiconducting metal oxide. Such interaction may be desirable for compounds having functional groups such as, for example, amide, amine, carboxylic acid, phosphonate and the like. Examples of suitable metal or metal alloy heterogeneous catalysts include, but are not limited to, colloidal platinum, colloidal palladium, colloidal nickel alloys and the like. Examples of a suitable metal or metal alloy deposited on the surface of a semiconducting metal oxide include, but are not limited to, titania with platinum deposited on the surface of the titania (platinized titania), zirconia with platinum deposited on the surface of the zirconia (platinized zirconia) and the like.

In an embodiment, the heterogeneous catalyst is a semiconducting metal oxide nanoparticle (e.g., having a diameter of from 5 nm to 100 nm, including all individual values and ranges therebetween). In another embodiment, the catalyst is a semiconducting metal oxide deposited on a substrate (e.g, a glass slide). In yet another embodiment, the catalyst is a semiconducting metal oxide bound in a polymer support. In any of these embodiments, a metal or metal alloy can be deposited on the metal oxide by conventional means (e.g., physical deposition or reduction of the appropriate metal halide salt(s).)

The sacrificial electron donor is any molecule which can reduce the compound (photosensitizer) that is oxidized during the formation of hydrogen. Examples of suitable sacrificial electron donors includes, but is not limited to, triethanolamine (TEOA), N,N-dimethylaniline, dimethylbenzylamine, N-phenylmorpholine, 1-dimethylaminonaphthalene, and the like.

Suitable electromagnetic radiation for use in the method has a wavelength or wavelengths that are absorbed by the compound. In an embodiment, the electromagnetic radiation has a wavelength or wavelengths in the range of 400 nm to 850 nm, including all integers therebetween. In another embodiment, the electromagnetic radiation has a wavelength from 500 to 750 nm. The electromagnetic radiation can be from any source which provides such wavelength(s). For example, a mercury xenon lamp (e.g. a 200 W lamp), a light emitting diode (LED) (e.g., 520 nm LED), a laser (e.g., a diode-pumped solid-state laser) and sunlight are examples of suitable sources of electromagnetic radiation.

Other parameters can be varied to achieve generation of hydrogen. For example, temperatures from 0 to 100 degrees Celsius, including all integers and ranges therebetween, can be used.

Concentrations of the components may also be varied to achieve generation of hydrogen. Examples of such follow. The photosensitizer concentration in solution (when a homogeneous catalyst is used) can be, for example, from 10⁻⁶ M to 10⁻³ M, including all values to the 1×10⁻⁶ and ranges therebetween, (this range will be extinction coefficient dependent, i.e., the higher the extinction coefficient the lower the concentration can be and vice versa). The photosensitizer concentration on titania or zirconia (heterogeneous catalyst used) can be, for example, from 10⁻⁹ mole/cm² (area of titania or zirconia) to 10⁻⁵ mole/cm², including all values to the 1×10⁻⁹ and ranges therebetween. The concentration of sacrificial electron donor concentration can be, for example, from 10⁻³ M to 1 M, including all values to the 1×10⁻³ and ranges therebetween. The homogeneous catalyst concentration can be, for example, from 10⁻⁵ M to 10⁻² M, including all values to the 1×10⁻⁵ and ranges therebetween. The amount of platinized titania or zirconia (a heterogeneous catalyst) can be, for example, from 0.02 to 2 wt-% metal, including all values to the 0.01 and ranges therebetween. The amount of colloidal palladium or platinum (also a heterogeneous catalyst) can be, for example, from 0.001 to 0.1 mg per mL, including all values to the 0.001 and ranges therebetween.

The pH of the aqueous solution may also be varied to achieve generation of hydrogen. The pH can be, for example, from 2 to 10, including all ranges and values to the 0.1 pH unit therebetween. In one embodiment, the pH value is between 5 and 7.

The present method can be used, for example, in devices that produce hydrogen. For example, the method can be used in a dye-sensitized solar cell (DSSC). DSSCs are promising alternatives to expensive silicon technology for conversion of solar radiation to electricity.

The following examples are presented to illustrate the present invention. They are not intended to limiting in any manner.

### EXAMPLE 1

### Example of Hydrogen Generation Using Heterogeneous Catalyst/Homogeneous Catalyst and Chalcogenoxanthylium

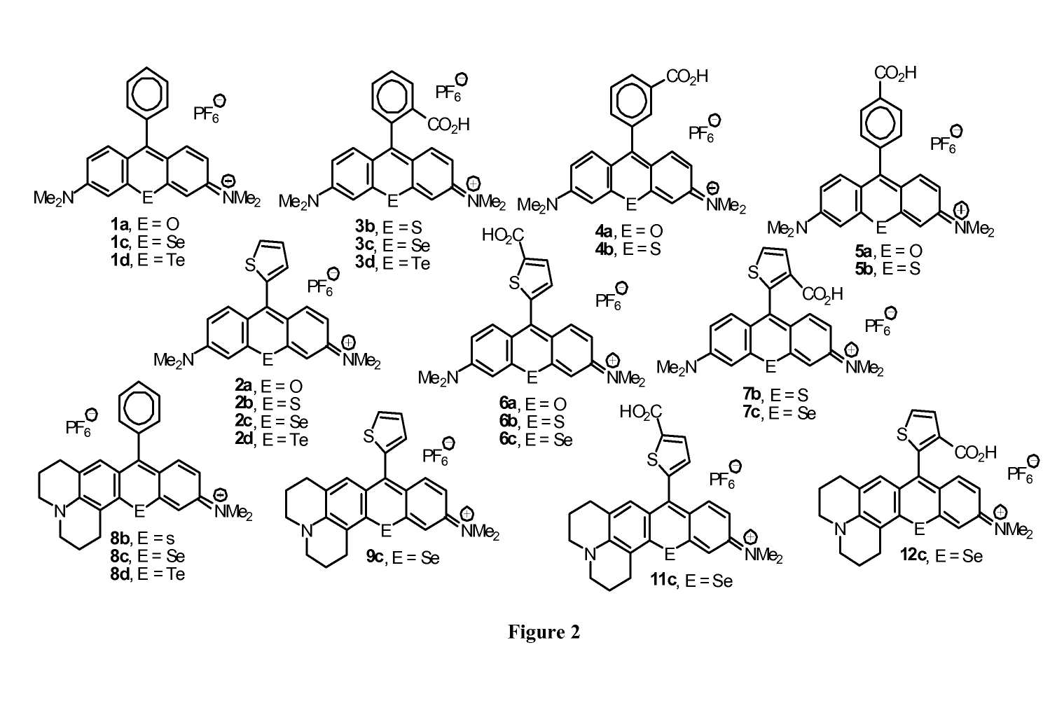

The dyes in FIG. 2 were prepared via methods previously described in above referenced U.S. patent application Ser. No. 11/195,393. For each chalcogenoxanthylium dye in Table 1, a 2×10⁻⁴M solution in acetonitrile was prepared. In a 20 mL test tube, 1 mL of the dye solution, 2 mL of 10% TEOA_{aq} solution (adjusted to pH 7 using HCl_{conc}), and either 1 mL of 1×10⁻³ M Co(dmgH)₂Cl(py) in acetonitrile or 1 mL acetonitrile and 4 mg 0.5% Pt/TiO₂. The samples were degassed by bubbling N₂ through the samples then 1 mL of the headspaces was replaced with methane at 760 torr to serve as an internal standard. The samples were irradiated with a 200 W Mercury Xexon lamp using a cut-off filter designed to remove all light with λ<450 nm. The amounts of hydrogen evolved were determined by gas chromatography using a Shimadzu GC-17A chromatograph with a TCD detector and a molecular sieve 5 Å column (30 m×0.53 mm).

In both the heterogeneous and in the homogeneous systems, the use of eosin (Ey) gave a turnover number (ton) of 51 turnovers/hour and continued to evolve hydrogen for 5 hours (Table 1). The turnover number or ton is the number of moles of hydrogen produced per mole of sye (sensitizer) per hour. All of the chalcogenorhodamine dyes in gave hydrogen evolution upon irradiation of 0.5% Pt/TiO₂ treated with the chalcogenorhodamines. Dyes 3b, 3c, 3d, 7b, and 7c on 0.5% Pt/TiO₂ gave more hydrogen evolution upon irradiation than eosin (Ey) treated 0.5% Pt/TiO₂. Dye 6b (ton of 50) was comparable to eosin (ton of 51) while the remaining chalcogenorhodamine dyes produced hydrogen at a slower rate than the eosin-Pt/TiO₂ system. Catalyst lifetimes for hydrogen evolution were on the order of 3-6 hours for the most productive dyes, which is comparable to the 5-hour lifetime observed for the eosin-Pt/TiO₂ system.

TABLE 1
Turnover number (ton) for the first hour of hydrogen evolution and
catalyst lifetimes for heterogeneous chalcogenorhodamine-treated
Pt/TiO₂ and homogeneous chalcogenorhodamine-treated Co(dmgH)₂Cl(py)
compared to eosin (Ey)-treated Pt/TiO₂ and Co(dmgH)₂Cl(py).

| | Heterogeneous | | Homogeneous | |
|---|---|---|---|---|
| Com- | 0.5% Pt/TiO₂, | Lifetime, | Co(dmgH)₂Cl(py), | Lifetime, |
| pound | turnover number | h | turnover number | h |
| Ey | 51 | 5 | 51 | 5 |
| 1a | 3 | 8 | 0 | — |
| 1c | 29 | 4 | 0 | — |
| 1d | 4.8 | 1 | 0 | — |
| 2b | 3 | — | 0 | — |
| 2c | 6.5 | — | 0 | — |
| 2d | 11 | >7 | 0 | — |
| 3b | 170 | 6 | 106 | 7 |
| 3c | 70 | 4 | 249 | 4 |
| 3d | 92 | — | 4.8 | >24 |
| 4a | 41 | — | 0 | — |
| 4b | 5 | 4 | 5 | 7 |
| 5a | 9 | — | 0 | — |
| 5b | 25 | 7 | 3 | 2 |
| 6a | 15 | — | 0 | — |
| 6b | 50 | 6 | 90 | >7 |
| 6c | 26 | 2 | 170 | 2 |
| 7b | 115 | 5 | 140 | 7 |
| 7c | 105 | 3 | 416 | 3 |
| 8b | 25 | 4 | 0 | — |
| 8c | 35 | 3 | 16 | 1 |
| 8d | 18 | >4 | 0 | — |
| 9c | 11 | >7 | 0 | — |
| 11c | 6 | 10 | 5.3 | 24 |
| 12c | 65 | — | 19 | 24 |

In the homogeneous system using dye-treated Co(dmgH)₂Cl(py), dyes 3b, 3c, 6b, 6c, 7b, and 7c gave greater hydrogen evolution than eosin-treated Co(dmgH)₂Cl(py) (Table 1). Interestingly, dyes 1a, 1c, 1d, 2b, 2c, 2d, 8b, 8d, and 9c that lacked a carboxylic acid group gave no hydrogen generation in the homogeneous system under the tested conditions. Dye 8c was the one exception with a ton of 16. The lifetime of dyes 3b, 3c, 6b, 6c, 7b, and 7c was on the order of 2-7 h, which was comparable to the 5 h lifetime observed with the eosin system.

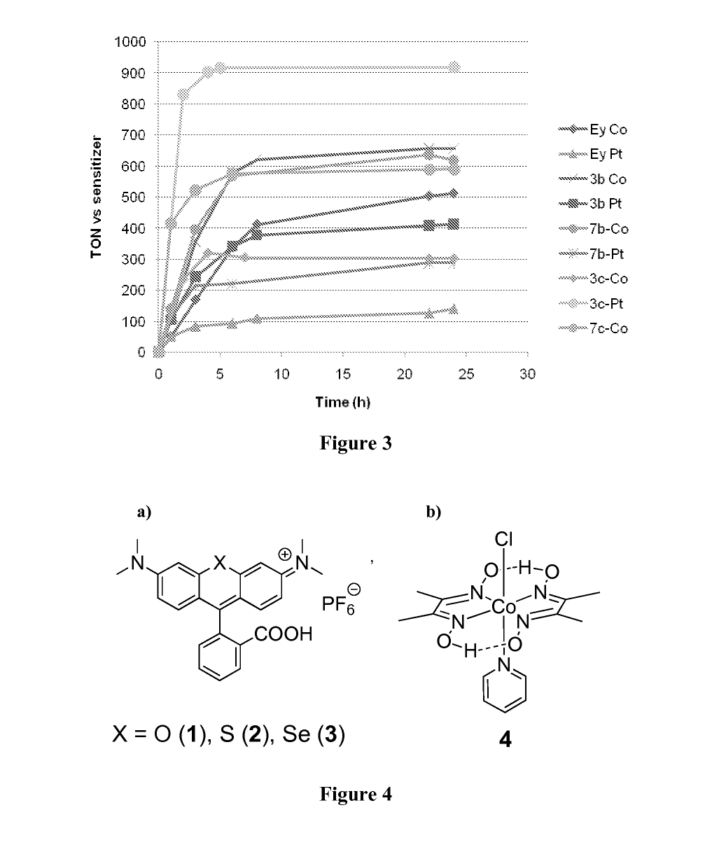

For the “better” chalcogenorhodamine dyes 3b, 3c, 7b, and 7c in the DPSs (e.g., a dye on platinized titania) for hydrogen evolution, FIG. 3 summarizes the total hydrogen evolution observed over the catalyst lifetime compared to the eosin (Ey)-sensitized systems. All four dyes gave more turnovers (290-600) than eosin (130) after 24 h in the heterogeneous Pt/TiO₂ system. In the homogeneous system with Co(dmgH)₂Cl(py), dyes 3b, 7b, and 7c gave more turnovers (590-660) than eosin (510) while 3c gave 300 turnovers.

### EXAMPLE 2

### Example of Hydrogen Generation Using Homogeneous Catalyst and Chalcogenoxanthylium Compound

In this example, rhodamine dye analogs containing S 2 or Se 3 in place of O (1) in the xanthene ring as shown in FIG. 4a were used. This system with dye 3 as the photosensitizer (PS) that shows the highest TOF yet reported for the photo-reduction of water (>5500 mol H₂/mol PS/hour and a turnover number (TON) per PS of over 9000 after 8 h). In addition to finding the most active PS to date for the evolution of H₂ from water, the details of a system that were previously difficult to examine with less active systems were elucidated. Through control of system component concentrations (catalyst, PS and TEOA), the overall stability, turnover frequency (TOF) and length of the induction period are altered, yielding insight into the photochemical steps of the reaction system.

Materials. The complex [Co^{II}(dmgH)₂pyCl] and the dyes 2 and 3 were synthesized by previously reported methods. All solvents were used without further purification unless otherwise stated. Dimethylgloxime was purchased from Aldrich and used without further purification. Absorption spectra were recorded using a Hitachi U2000 scanning spectrophotometer.

Synthesis of Rhodamine Dye (1). A previously described method for the preparation of a bis(diethylamino) analogue was modified to produce dye 1. N,N-Dimethylaminophenol (500.0 mg, 3.65 mmol), phthalic anhydride(648 mg, 4.37 mmol), and 1-decene (2.75 mL, 14.6 mmol) was added to a flame dried flask equipped with Hickman stillhead and reflux condenser under argon. An additional 2 mL of 1-decene was added to the stillhead and the resulting mixture was heated at 175° C. while stirring. After 3 hours of stirring, N,N-dimethylaminophenol (65.0 mg, 0.474 mmol) was added once every hour over the following five hours. The hot reaction was poured into stirring cold NaOH (1 M, 100 mL). Dichloromethane (50 mL) was added and allowed to stir 30 minutes before extracting (3×20 mL). The organic layers were mixed with 4.5% H₂SO₄ and stirred 30 minutes. To the separated aqueous layer was added 35% HPF₆ (50 mL) and saturated NaPF₆(50 mL). The mixture was stirred overnight at 70° C., and the resulting green solid was filtered while washing with 2% HCl followed by ether and then dried under reduced pressure to yield 467 mg of product (25.2% yield): ¹H NMR (300 mHz, CD₃OD) δ 8.25 (d, 1H, J=7.5 Hz), 7.78 (m, 2H), 7.32 (d, 1H, J=7.5 Hz), 7.01 (d, 2H, J=9.3 Hz), 6.97 (dd, 2H, J=2.1 Hz, 9.3 Hz), 6.86 (d, 2H, J=2.1 Hz), 3.20 (s, 12H). ¹³C NMR (75 mHz, CD₃OD) δ 168.05, 161.87, 159.12, 158.94, 135.34, 133.86, 132.55, 132.13, 131.46, 115.45, 114.98, 97.40, 40.93. HRMS m/z 387.1700 (calcd for C₂₄H₂₃O₃N₂: 387.1703).

Hydrogen evolution studies. For each dye a 2×10⁻⁴M solution in acetonitrile was prepared. A 5×10⁻³M solution of 4 in acetonitrile was prepared. In a 20 mL test tube, a varying amount of the dye solution, and a varying amount of the 4 solution was added, and the volume was made up to 2 mL. A 10% TEOA_{aq} solution (2 mL) (adjusted to specified pH using HCl_{conc}) was added. A septum was placed on the test tubes and secured with a copper wire. The samples were degassed by bubbling N₂ through the samples for 15 minutes then 1 mL of the headspaces was replaced with methane at 760 torr to serve as an internal gas chromatography (GC) standard. The samples were placed on a carousal to ensure equal light reaching all six samples and were irradiated with a 200 W Mercury Xenon lamp using a cut-off filter designed to remove all light with λ<455 nm. The samples were stirred with magnetic stir bars during irradiation. The amounts of hydrogen evolved were determined by GC using a Shimadzu GC-17A chromatograph with a molecular sieve 5 Å column (30 m-0.53 mm) and a TCD detector by injecting 100 μL of headspace into the GC, quantified by a calibration plot to the internal CH₄ standard.

LED photolysis set-up. Samples of 5 mL were prepared in 40 mL scintillation vials. For each dye a 2×10⁻⁴M solution in acetonitrile was prepared. A 5×10⁻³M solution of 4 in acetonitrile was prepared. A varying amount of the dye solution, and a varying amount of the 4 solution was added, and the volume was made up to 2.5 mL. A 10% TEOA_{aq} solution (2.5 mL) (adjusted to pH 7 using HCl_{conc}) was added. The samples were placed into temperature controlled block at 15° C. and sealed with an air tight cap fitted with a pressure transducer and septa. The samples were degassed by bubbling with a mixture of 20% mixture of CH₄ in N₂, where the CH₄ was later used as the internal standard for GC analysis. The cells were irradiated from below with a high power Philips LumiLEDs Luxeon Star Hex green (520 nm) 700 mA LEDs. The light power of each LED was set to 0.15 W measured with a L30 A Thermal sensor and Nova II Power meter (Ophir-Spiricon LLC). The samples were mixed by placing the apparatus on an orbital shaker. The pressure changes in the vials were recorded using a Labview program read from a Freesale semiconductor pressure sensor (MPX4250A series). At the end of the irradiation the headspace of the vials were sampled by the GC to ensure the pressure change was caused by H₂ generation, and to double check that the amount of generated hydrogen calculated by the change in pressure corresponded to the amount determined by the GC.

Cyclic Voltammetry. Cyclic voltammetry measurements of the solvated dyes were made with a PAR 263A potentiostat/galvanostat cycling at 0.1 or 0.25 V/s, using a one-compartment cell with a Pt-wire working electrode, a Pt-mesh counter electrode, and an SCE reference electrode. The electrolyte was 0.2 M tetrabutylammonium tetrafluoroborate in degassed acetonitrile solutions of 5×10⁻⁴ M chalcogenorhodamine dye 1, 2, or 3. All samples were run in HPLC-grade acetonitrile that had been stored over 3 Å molecular sieves and freshly distilled prior to use. Tetrabutylammonium fluoroborate (Aldrich Chemical Co.) was recrystallized from ethyl acetate/ether and then dried overnight at 80° C. before it was used as supporting electrolyte at 0.2 M. Nitrogen was used for sample deoxygenation.

Fluorescence Quenching. A 1×10⁻⁶ M solution of 2 or 3 in a 3:1 mixture of CH₃CN:H₂O was prepared and deoxygenated by bubbling N₂ into a quartz cuvette fitted with a septum cap. Aliquots of a solution of either TEOA or 4 were added and the intensity of the fluorescence was monitored by steady state fluorescence exciting at 560 nm for 2 and 570 nm for (3) on a Spex Fluoromax-P fluorimeter with a photomultiplier tube detector.

Phosphorescence Quenching. A 1×10⁻⁵ M solution of 3 in a 3:1 mixture of CH₃CN:H₂O was prepared and deoxygenated by bubbling N₂ into a quartz cuvette fitted with a septa cap. Aliquots of a solution of either TEOA or 4 were added and the intensity of the emission was monitored on a liquid-nitrogen-cooled Acton Instrument North Coast Scienctific Grp. Ge IR detector with single-photon counting with a Spectra Pro 300i 0.300 m triple grating monochromator, exciting at 580 nm with a 450 W xenon lamp, with a 150 dual spectra pro grating.

Quantum yield. The difference between the power of light passing through blank, and through the sample containing only 5×10⁻⁵ M 4 was used to calculate the light absorbed by the dye, for four samples, with 4×10⁻⁶ M, 8×10⁻⁶ M, 1.2×10⁻⁵ M and 2×10⁻⁵ M of either (2) or (3) with CH₃CN:H₂O 1:1 5% v TEOA. The power of light passing through the blank and the power passing through the sample was measured with a L30 A Thermal sensor and Nova II Power meter (Ophir-Spiricon LLC) from the 520 nm high power LEDs. The average rate of hydrogen production was determined by taking the slope of the line of H₂ vs time for over the first hour. The quantum efficiency was calculated by determining the number of moles of hydrogen produced per second, and dividing it by the number of moles of photons absorbed by the system per second.

photons/sec=Pλ/hc

Where P was determined using the difference in power of the light between the blank and the sample (in W), λ was taken to be 520 nm, h is Plank's constant, c is the speed of light. It is assumed that for every photon absorbed two electrons are produced through the decomposition of TEOA, and as such each photon should lead to one molecule of H₂ since two electrons are needed. The average of the quantum yield for each sample was taken and the standard deviation is cited as the error.

TABLE 2

| Concentration | Rate | Absorbed power | Photon flux | Φ_{H2} |
|---|---|---|---|---|
| of PS | (mol H₂/s) | (W) | (mol photon/s) | (%) |
| 4.0 × 10⁻⁶ M 2 | 9.37 × 10⁻⁹ | 0.02 | 8.69 × 10⁻⁸ | 10.8 |
| 8.0 × 10⁻⁶M 2 | 1.79 × 10⁻⁸ | 0.03 | 1.30 × 10⁻⁷ | 13.6 |
| 1.2 × 10⁻⁵M 2 | 2.30 × 10⁻⁸ | 0.043 | 1.87 × 10⁻⁷ | 12.3 |
| 2.0 × 10⁻⁵M 2 | 3.35 × 10⁻⁸ | 0.063 | 2.74 × 10⁻⁷ | 12.2 |
| 4.0 × 10⁻⁶M 3 | 2.85 × 10⁻⁸ | 0.02 | 8.69 × 10⁻⁸ | 32.8 |
| 8.0 × 10⁻⁶M 3 | 3.26 × 10⁻⁸ | 0.023 | 9.99 × 10⁻⁸ | 32.6 |
| 1.2 × 10⁻⁵M 3 | 3.89 × 10⁻⁸ | 0.026 | 1.13 × 10⁻⁷ | 34.4 |
| 2.0 × 10⁻⁵M 3 | 5.57 × 10⁻⁸ | 0.041 | 1.78 × 10⁻⁷ | 31.3 |

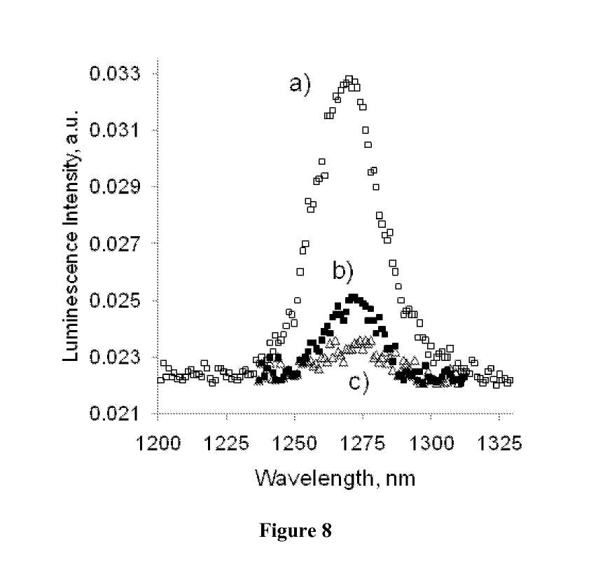

Triplet/Singlet Oxygen Yields for Chalcogenoxanthylium Dyes 1-3, 5a-c. Singlet oxygen yields, Φ(¹O₂), have been reported for tetramethylrosamine dyes 5a-c (FIG. 7). These values are compiled in Table 3. Triplet yields, γ_{T} have been reported for tetramethylrosamine dyes 1-3 and are nearly identical to values of Φ(¹O₂) as shown in Table 3. For practical purposes with rhodamine-related dyes, the quenching of triplets by O₂ is highly efficient and values of Φ(¹O₂) can be assumed to be nearly identical to values of γ_{T}. The luminescence spectra of singlet oxygen produced by irradiation of dyes 1-3 in methanol at 293 K were compared to that of Rose Bengal as a reference (Φ(¹O₂)=0.80^{S6}). Observable signals were present for all three dyes as shown in FIG. 8 and values of Φ(¹O₂) were calculated to be 0.05±0.03 for 1, 0.17±0.01 for 2, and 0.67±0.01 for 3 (Table 4).

TABLE 3
Triplet Yields (γ_{T}) Rosamine Dyes 5a-c and Singlet Oxygen Yields
(Φ(¹O₂)) for dyes 1-3 and 5a-c in methanol.

| Compound | E | 9-Ar | γ_{T} | Φ(¹O₂) |
|---|---|---|---|---|
| 5a | O | C₆H₅ | 0.09 | 0.08 |
| 5b | S | C₆H₅ | 0.23 | 0.21 |
| 5c | Se | C₆H₅ | 0.97 | 0.87 |
| 1 | O | 2-(HO₂C)C₆H₄ | — | 0.05 ± 0.03 |
| 2 | S | 2-(HO₂C)C₆H₄ | — | 0.17 ± 0.01 |
| 3 | Se | 2-(HO₂C)C₆H₄ | — | 0.67 ± 0.01 |

Singlet Oxygen Quantum Yields by Direct Methods. Rose Bengal was purchased from Fisher Scientific (Hampton, N.H.) and was used as the reference during measurement of singlet oxygen yields (singlet oxygen yield in methanol: Φ(¹O₂)=0.80). Methanol was purchased from Sigma-Aldrich and was used as received. A SPEX 270M spectrometer (Jobin Yvon) equipped with an InGaAs photodetector (Electrooptical Systems Inc., USA) was used for acquisition of singlet-oxygen emission spectra in the near-IR spectral range. A diode-pumped solid-state laser (Verdi, Coherent) at 532 nm was the excitation source. The air-saturated sample solution in a quartz cuvette was placed directly in front of the entrance slit of the spectrometer, and the exciting laser beam was directed at 90° relative to the collection of emission. A long-pass filter, 950 LP (Omega Optical, USA), was used to attenuate the excitation laser light and fluorescence from the dyes in order to quantify singlet oxygen phosphorescence at 1270 nm. The optical density at 532 nm for all solutions was adjusted to be 0.4 prior to irradiation.

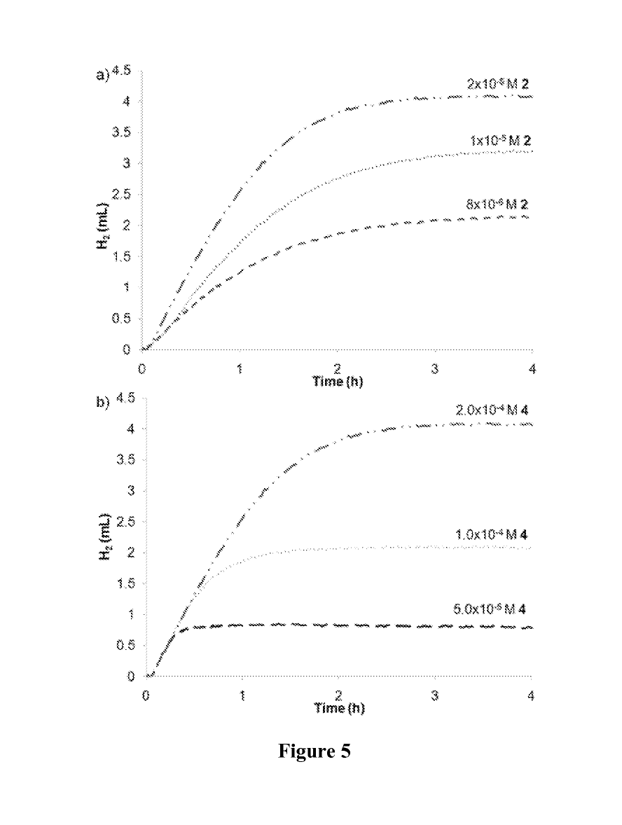

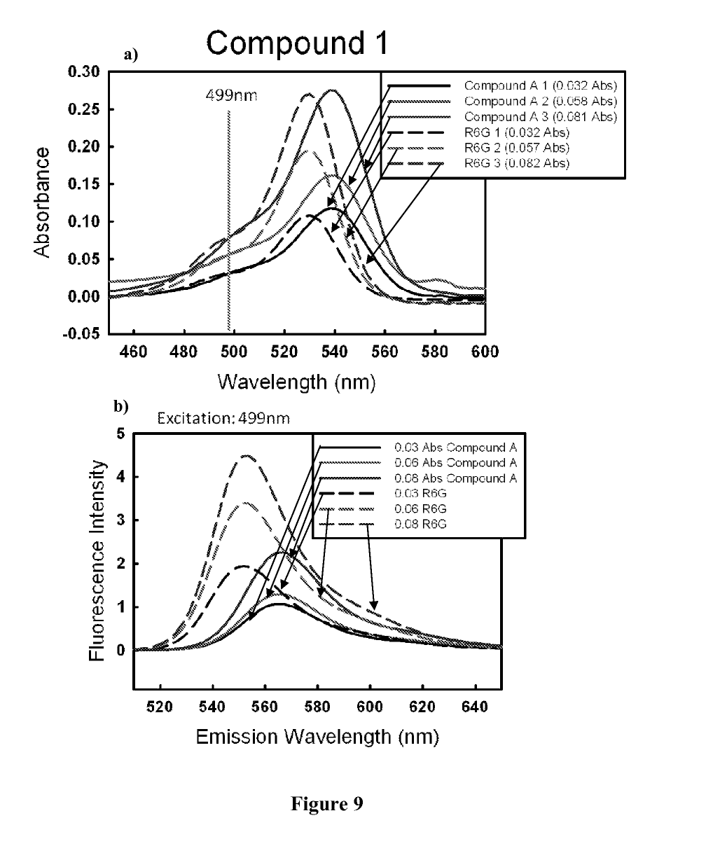

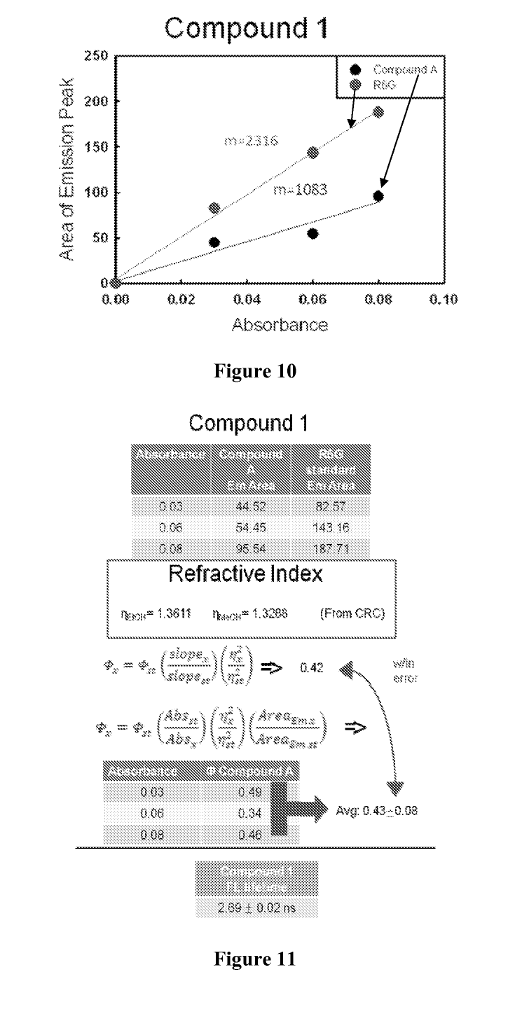

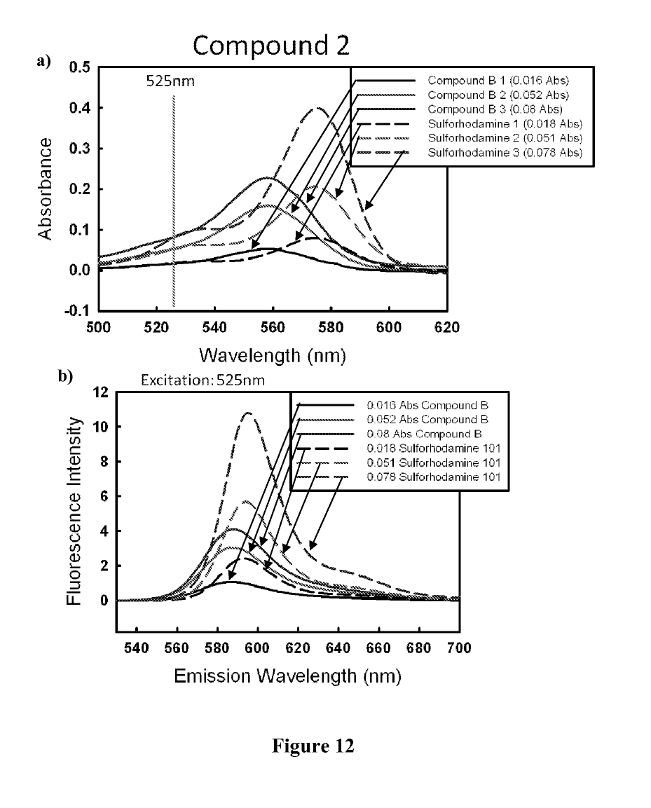

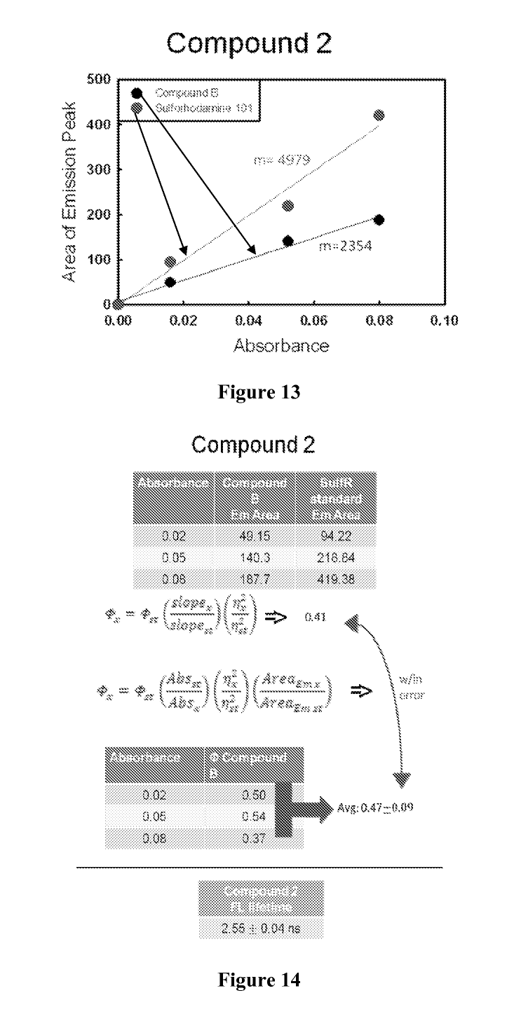

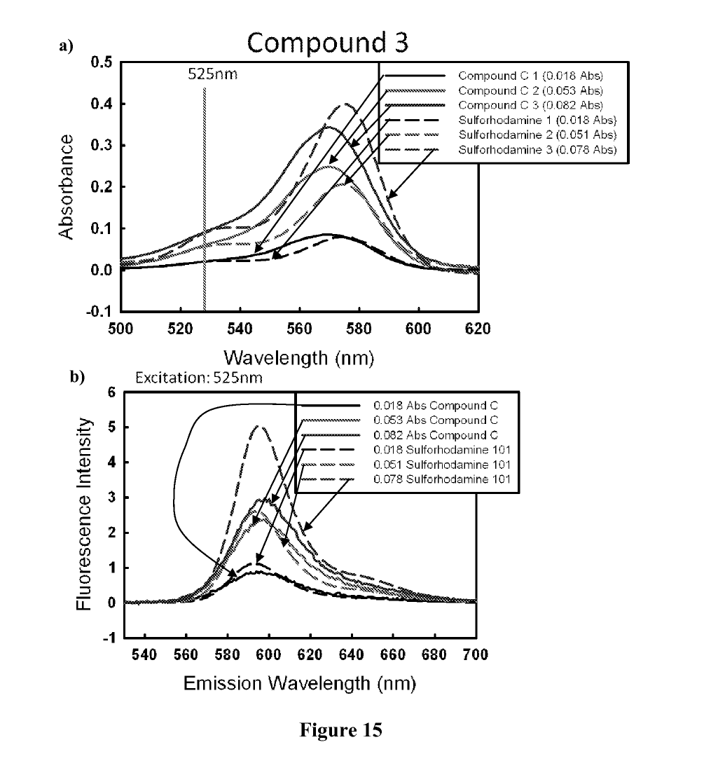

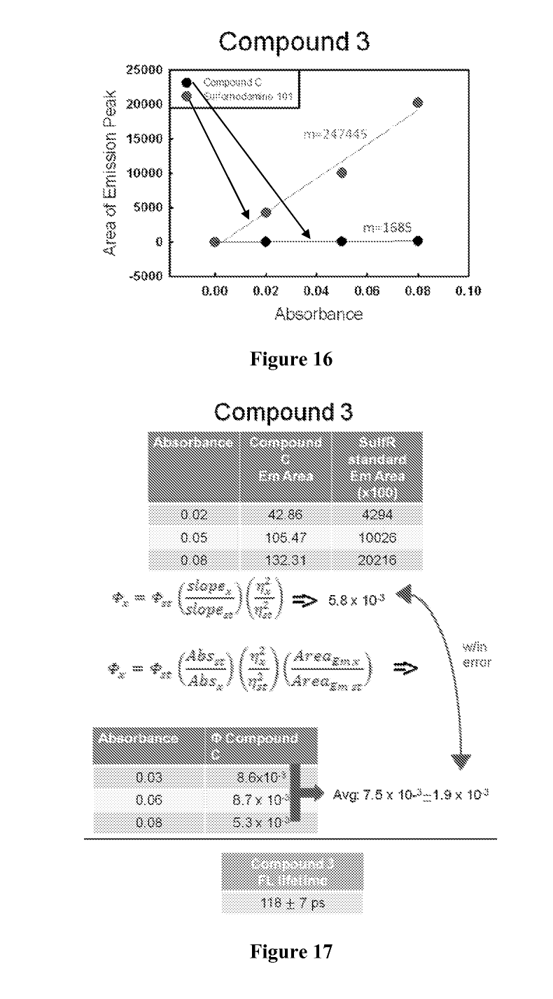

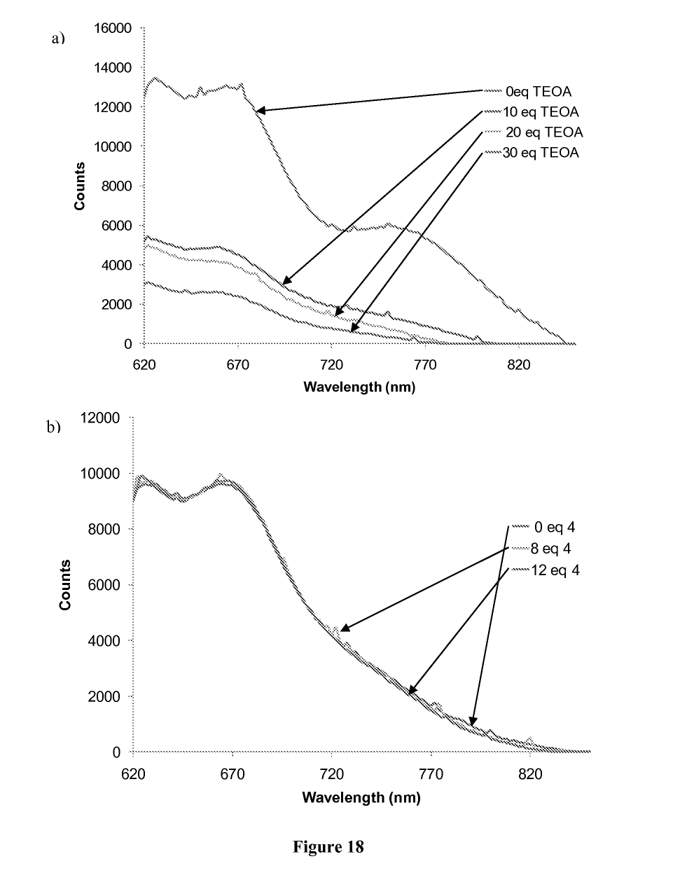

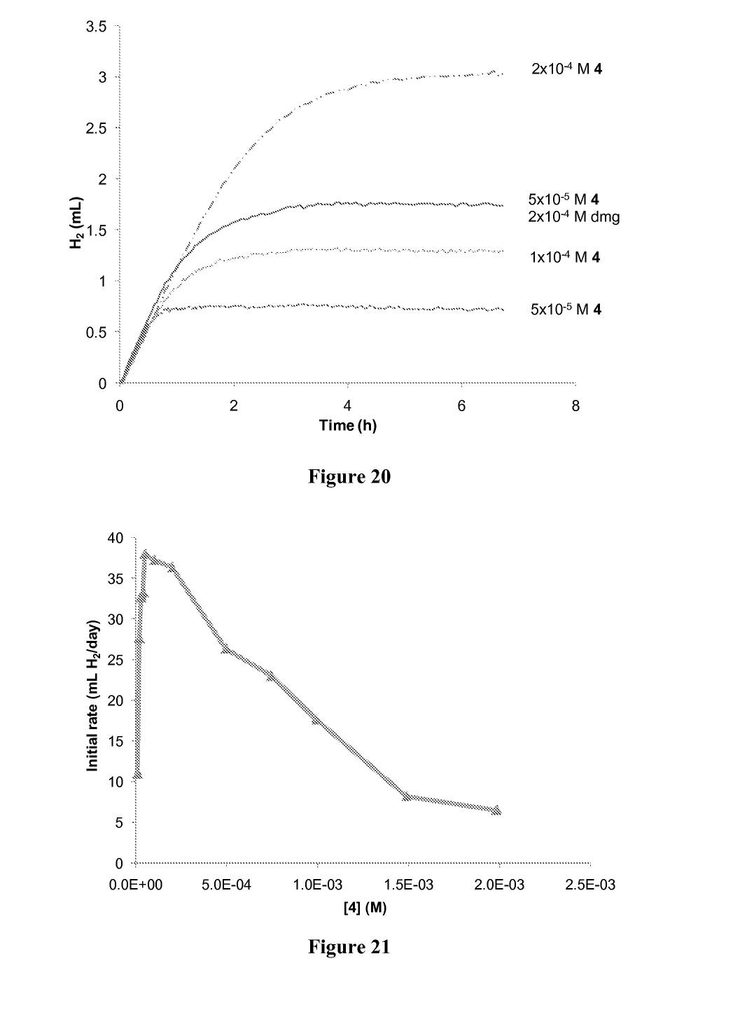

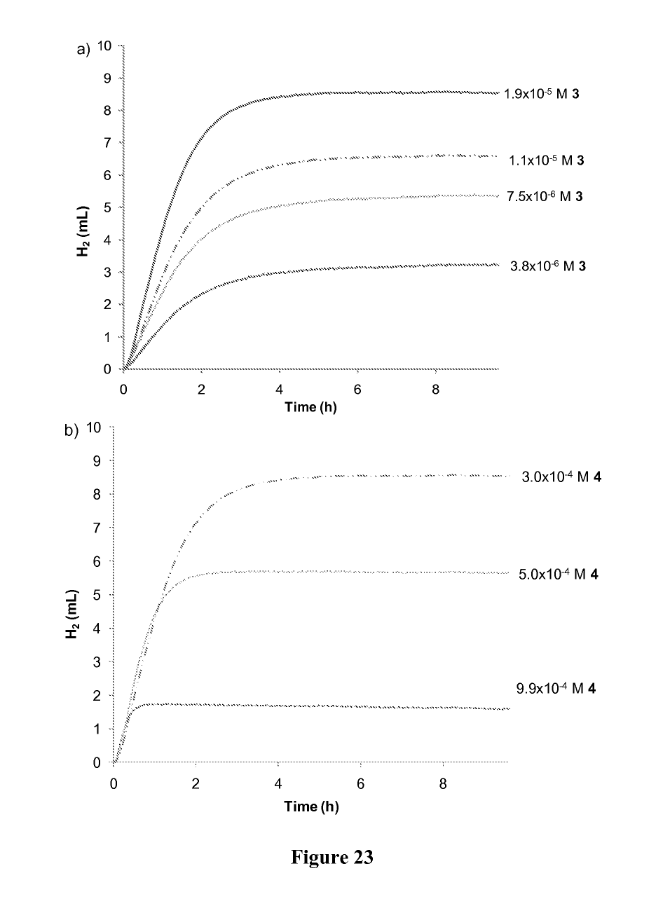

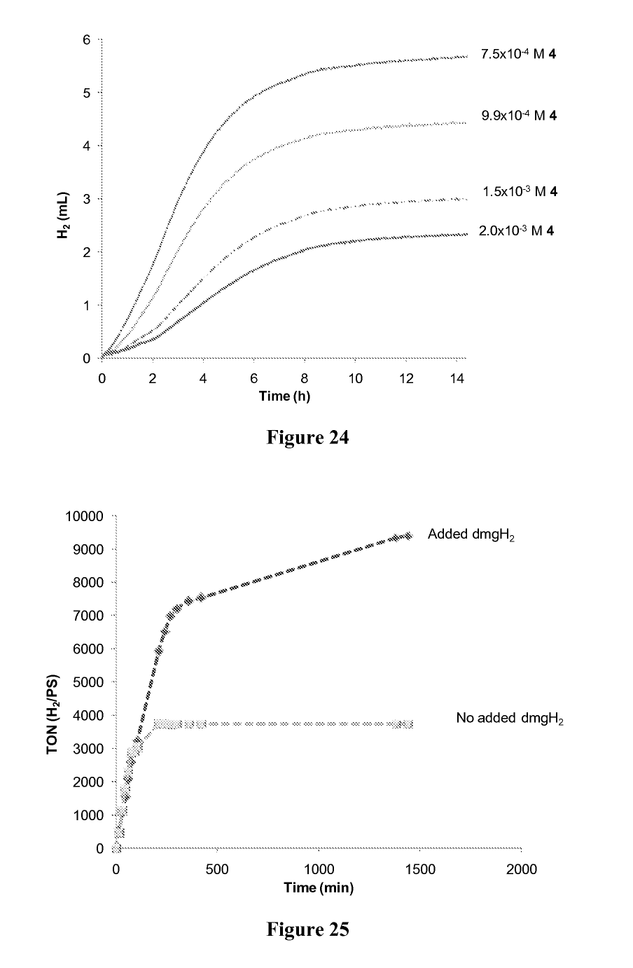

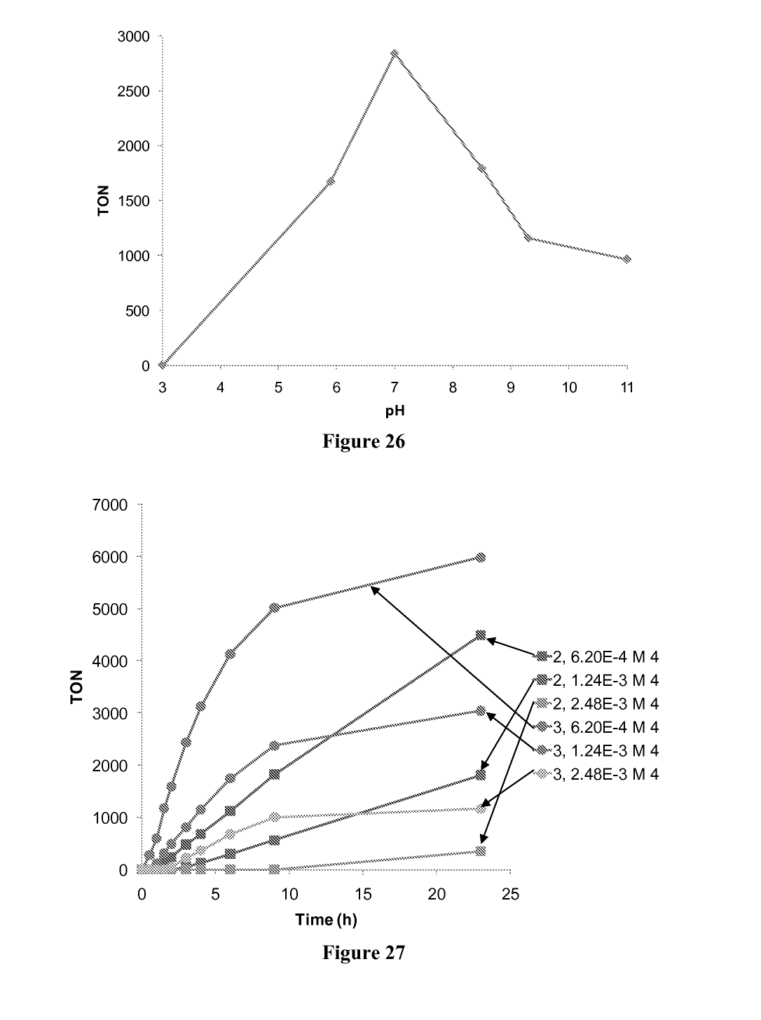

Fluorescence Quantum Yields (Φ_{FL}) and Fluorescence Lifetimes (τ_{FL}). All samples were measured in 1-cm² quartz cuvettes. Electronic absorbance measurements were acquired by using a Hewlett Packard diode array spectrometer with the appropriate sample blanks. Emission spectra were acquired on a SLM AMINCO model 8100 fluorometer (λₑₓ:499 nm for 1; λₑₓ:525 nm for 2 and 3). A single emission monochromator scanned a range of emission wavelengths which were detected using a photomultiplier tube. A reference channel was used simultaneously with the standard reference fluorophore (rhodamine B) to account for any fluctuations in the excitation source. Fluorescence lifetimes were determined in the frequency domain by using a SLM AMINCO model 48000 MHF from 5 to 250 MHz. Appropriate wavelength CW laser lines were used to excite the various compounds (λₑₓ:514 nm for compounds 1 and 2; λₑₓ:532 nm for compound 3). Rhodamine 6G (R6G) was used as a reference lifetime standard for 1 and sulforhodamine 101 for 2 and 3. Emission was collected through appropriate long pass filters. Lifetime values were recovered from the experimental phase-modulation data by using GLOBALS WE® (Globals Unlimited), a commercially available nonlinear least-squares analysis program. Experimental data and calculations are shown in FIGS. 5, 8-27.

The TOF's for systems using 1-3 as PS with irradiation from 520-nm LEDs (0.15 W, 5% TEOA in 1:1 CH₃CN:H₂O, pH 7) are 0, 1700 and 5500 TON/hour, respectively. While the system containing 1 as the PS did not produce H₂, quantum yields for H₂ production (Φ_{H2}) for the systems containing 2 and 3 are very high, 12.2±1.2% and 32.8±1.4%, respectively, as calculated using power meter measurements of the incident photon flux and analysis of photogenerated H₂ by the pressure change in the reaction flask and g. c. analysis. These are among the highest yet reported. In the quantum yield analysis, two electrons per incident photon are assumed since TEOA upon oxidation decomposes with transfer of a second reducing electron. Since the redox potentials and emission energies of 1, 2 and 3 are similar, (Table 4), the inactivity of the system containing 1 cannot lie with the energetics of its excited state, but rather with the kinetics of the excited state from which electron transfer occurs.

TABLE 4
Electrochemical and photophysical properties of dyes 1-3 and rates of H₂ generation
for a systems with 4 as the catalyst.

| | | | | λₘₐₓ | | | | | |
|---|---|---|---|---|---|---|---|---|---|
| | Red | Ox. | λₘₐₓ abs (nm) | em | Φ_{F} | | | | |
| | (V)^{b} | (V)^{b} | (ε M⁻¹ cm⁻¹)^{c} | (nm)^{d} | emission^{d} | τ_{FL} (ns)^{d} | Φ (¹O₂)^{d} | TOF^{e} | Φ_{H2} |
| 1 | −0.75 | +1.23^{a} | 547 nm | 580 | 0.43 ± 0.08 | 2.69 ± 0.02 | 0.05 ± 0.03 | 0 | 0% |
| | | | (59000)^{c} | | | | | | |
| 2 | −0.66^{a} | +1.28 | 560 nm | 590 | 0.47 ± 0.09 | 2.55 ± 0.04 | 0.17 ± 0.01 | 1700 | 12.2% |
| | | | (72000) | | | | | | |
| 3 | −0.54 | +1.46 | 570 nm | 600 | 0.075 ± 0.019 | 0.118 ± 0.007 | 0.67 ± 0.01 | 5500 | 32.8% |
| | | | (51000) | | | | | | |

^{a}Quasireversible with iₚ^{c}/iₚ^{a} < 0.8 for oxidations or iₚ^{a}/iₚ^{c} < 0.8 for reductions, scan speed of 0.25 V s⁻¹; irreversible at 0.1 V s⁻¹
^{b}Measured in acetonitrile.
^{c}Acetonitrile with 0.1% 1M HCl added.
^{d}In methanol.
^{e}Mol of H₂/mol of photosensitizer per hour.

While the fluorescence lifetimes, τ_{FL}, for dyes 1 and 2 are similar and 20-fold shorter for 3 (2.69±0.02 ns for 1, 2.55±0.04 ns for 2, and 0.118±0.007 ns for 3) (Table 4), the presence of S and Se in 2 and 3 facilitates ISC that leads to population of the longer-lived triplet excited states from which electron transfer occur. The intersystem crossing efficiencies of 1-3 can be estimated from quantum yields for singlet oxygen generation [Φ(¹O₂)] through ³PS* quenching by molecular oxygen. Experimentally determined values of Φ(¹O₂) are 0.05±0.03 for 1, 0.17±0.01 for 2, and 0.67±0.01 for 3 (Table 4). Although the triplet lifetimes for 2 and 3 were not measured, the analogs of 2 and 3, not having the —COOH substituent (a tetramethylrosamine dye analog) have a reported triplet excited-state lifetime, τ_{T}, of 1-2 μs and ˜340 ns in MeOH at 293 K respectively, both of which are >1000-fold longer than the corresponding singlet excited state.

The ³PS excited state is therefore long enough lived for bimolecular electron transfer leading to H₂ generation to be favorable relative to radiative and non-radiative decay back to the ground state. Electron transfer quenching of the ³PS excited state can be either oxidative or reductive, leading respectively to PS⁺ with electron transfer from the dye to the catalyst or PS with electron transfer to the dye from the sacrificial reductant TEOA. For 2 and 3 with their higher ISC efficiencies, electron-transfer quenching provides the path to H₂ generation. In fact, an excellent correlation can be seen in Table 4 between the ¹O₂ yields for these dyes and both the TOF and Φ_{H2}.

Electron transfer from the ³PS excited state of 3 was confirmed through emission quenching studies. As expected, neither TEOA nor the catalyst 4 quenches the singlet state (¹PS*) fluorescence (600 nm) of 3. In contrast, the triplet state phosphorescence of 3 (750 nm) is quenched by TEOA, but not by Co complex 4, as shown in emission spectra of 3 that decreases only with the addition of TEOA and not with 4. These observations indicate that electron transfer comes from the ³PS excited state through a reductive quenching mechanism only.

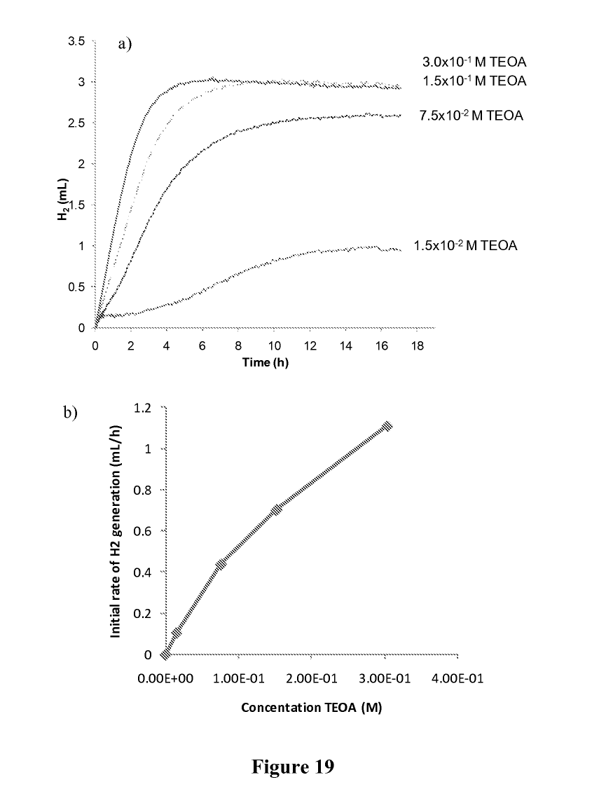

Plots of H₂ generation as a function of different component concentrations from irradiation at 520 nm are shown in FIG. 5. In these plots, rapid and nearly linear initial rates give way to photodecomposition and cessation of H₂ production. FIG. 5a shows the effect of PS concentration, whereas FIG. 5b reveals the influence of Co catalyst concentration. As seen in FIG. 5a, both the initial rate and the total amount of H₂ produced increase as PS concentration is increased, although the TON's based on mol of H₂ per mol of PS actually decrease as [PS] increases, possibly due to greater collisional deactivation of the ³PS excited state. The influence of [PS] on the H₂ generation rate suggests that the reduction of the PS is rate limiting. This is supported by the pseudo-linear rate dependence for H₂ formation on TEOA concentration, since the TEOA would be involved in the reductive quenching of the PS excited state (see FIG. 19). In FIG. 5b, the initial rates of H₂ generation are similar for all three catalyst concentrations, [4], in the range of 5×10⁻⁵-2×10⁻⁴ M, but system longevity for making H₂ is affected. At higher values of [4], H₂ generation lasts longer, resulting in greater total amounts of H₂. These data are consistent with two competing pathways for the reduced PS: non-destructive electron transfer to the catalyst and a competitive unimolecular degradation pathway for PS⁻. The partitioning of PS⁻ between these two pathways is affected by [4]; at higher concentrations of 4, H₂ formation is more favorable relative to first order decomposition of PS⁻.

As [4] is increased beyond 5×10⁻⁴ M, an induction period for H₂ production is noted and the TON's based on PS concentration decrease (see FIG. 19). It has previously been proposed based on studies using 4 with a different PS that H₂ generation occurs with reduction of Co(II) to Co(I) followed by protonation to form a Co(III) hydride intermediate. For 4 which is a Co(III) complex, initial reduction of Co(III) to Co(II) must occur prior to H₂ generation, and at higher values of [4] this initial reduction leads to the observed induction period. This hypothesis is supported by running the reaction with Co^{II}(BF₄)₂.6H₂O and free dmgH as the catalyst precursors; no induction period is observed under these conditions. The activity of the system can be prolonged leading to greater H₂ formation by the addition of extra dmgH₂ ligand to the system. A system with 5×10⁻⁵ M of 4 and 2×10⁻⁴ M of extra dmgH₂ (3×10⁻⁴ M dmgH total) is longer lived (2 hours) and produces more H₂ than a system with more Co, but less total dmgH, with 1×10⁻⁴M of 4 (2×10⁻⁴ M of coordinated dmgH), and is shorter lived than a system with 2×10⁻⁴ M 4 (4×10⁻⁴ M coordinated dmgH) (4 hours) (see FIG. 25). It thus appears that the dimethylglyoxime ligand is being degraded during the course of the photolysis and is a key cause of system instability. It also suggests that the coordinated dmgH ligand is labile and undergoes exchange with free dmgH₂ in solution. Nevertheless, through the addition of extra dmgH₂ during the course of the photolysis, more than 9000 turnovers/PS of H₂ in 8 hours has been achieved with irradiation at 520 nm.

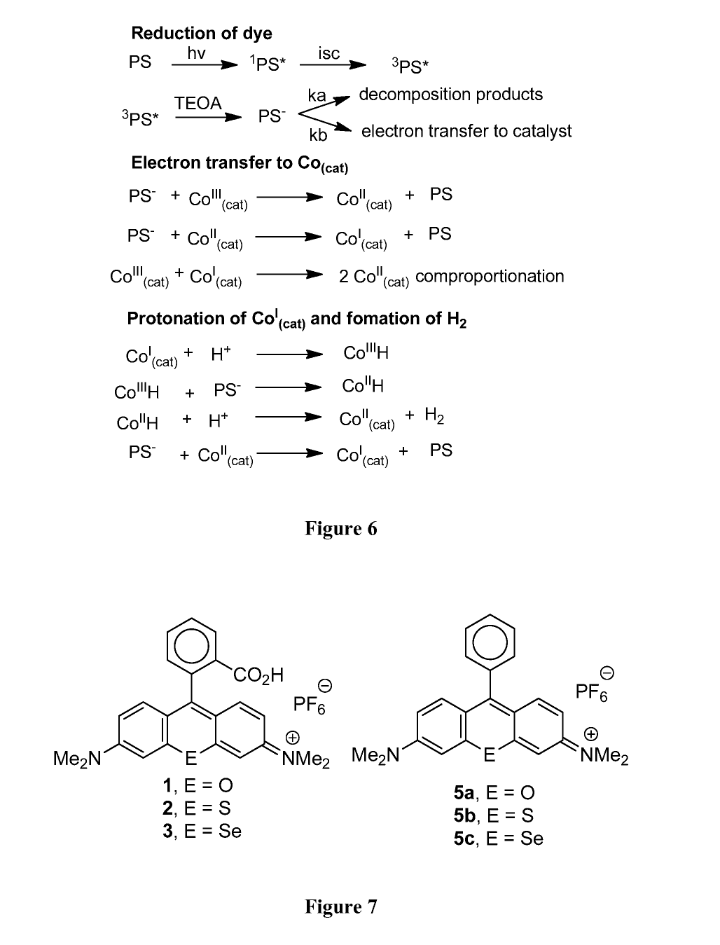

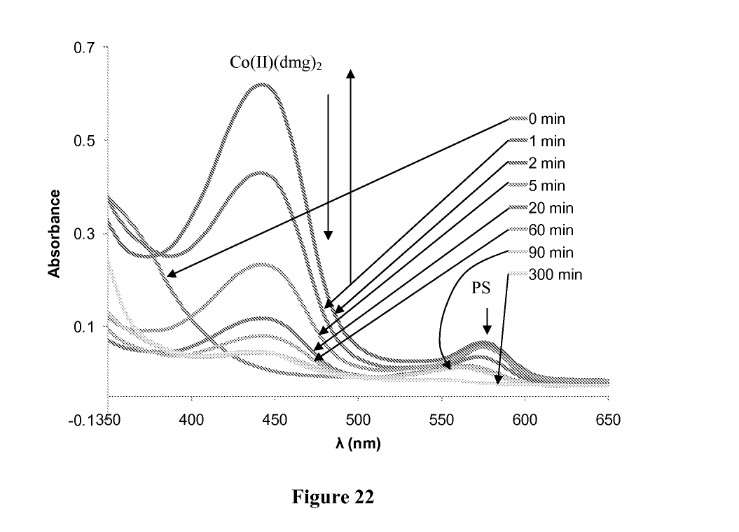

When the concentration of 4 is low enough such that the catalyst is rate limiting, there is a linear dependence of the initial rate of H₂ generation with respect to the concentration of 4 (see FIG. 22). This observation is consistent with previous reports in which the H₂-generating mechanism is found to be first order in cobalt. At low concentration of catalyst, however, the system degrades quickly as can be observed by the cessation of H₂ evolution and a color change associated with a bleach of the PS. Addition of either 4 or PS alone does not restart H₂ generation indicating that both catalyst and PS undergo decomposition when H₂ production stops. Addition of both catalyst and PS are needed for the system to restart H₂ generation. The actual mechanism by which the Co(III) hydride reacts further to form H₂—by either monometallic or bimetallic pathways—remains uncertain and may in fact be system dependent. The pathway favored by us based on the linear relationship of H₂ formation with [4] is shown in Scheme I (see FIG. 6), along with the photochemical steps of the system.

Bleaching of photosensitizers 2 and 3 during H₂ generation contrasts with the fact that they are stable under continuous irradiation with λ>455 nm in MeCN/H₂O solutions. However, a solution of only the PS and TEOA degrades very rapidly under irradiation. The lifetime of the dye in the presence of TEOA can be prolonged, by the addition of 4 as an electron acceptor. When followed by UV-Vis spectroscopy for a system containing 3, the band assigned to Co(II)(dmg)₂ at 440 nm grows in over a few minutes, followed by a slow bleach of this band over the next hour, indicating catalyst decomposition. The intensity of the PS absorption at 570 nm for 3 decreases only slightly for the first half hour of irradiation, and then rapidly when the 440 nm band becomes weak (Supporting Information). It thus appears that decomposition of the PS and the catalyst are coupled.

The fact that reductive quenching leads to H₂ formation and at the same time leads to PS decomposition when Co(II)(dmgH)₂ is no longer present suggests a branch point in the photochemical cycle. At high concentrations of [Co(II)(dmgH)₂], electron transfer from PS⁻ to the catalyst results in H₂ generation, while at very low concentrations of [Co(II)(dmgH)₂], unimolecular photo-decomposition of the PS becomes favored over electron transfer and subsequent productive chemistry. FIG. 2 is consistent with this analysis. The rate of H₂ generation is initially constant, indicating constant PS concentration. However, during the photolysis, the concentration of [4], initially present in sizable excess, declines. While this is not observed as a change in H₂ production rate, when the concentration of catalyst becomes too low, partitioning of PS to decomposition becomes increasingly favored, as a rapid decline and cessation of H₂ production occur as first catalyst and then PS photodecompose.

The activity and stability of the systems we have reported rely on both favorable thermodynamics and kinetics for the steps leading to H₂ generation. There are several branch points in Scheme I from which two competing paths exist; appropriate conditions must be used so that the desired path can dominate. First, the ³PS excited state is crucial for H₂ generation because its longer lifetime allows bimolecular electron transfer to compete effectively with radiative and non-radiative decay paths. Second, operating stability of the PS depends on the rate of electron transfer by PS⁻ to the Co catalyst relative to unimolecular decomposition. Third, added dmgH₂ extends the functional lifetime of the system, most likely through ligand exchange. Each of these factors is under active study going forward including new sacrificial electron donors, catalysts more resistant to decomposition, and PS's that can either tolerate reductive quenching or function by an oxidative quenching pathway.

In summary, S- and Se-substituted rhodamine dyes have been used as PS's for the photogeneration of H₂ from water in a system containing Co(dmgH)₂pyCl as the catalyst and TEOA as the sacrificial electron donor. The system is highly active and has allowed elucidation of the photochemical steps for H₂ production and system decomposition. Knowledge of these steps is essential for the design of more effective systems for the reductive side of water splitting.

TABLE 5
The TON given in terms of PS, catalyst 4, and dmg concentrations for the plots in
FIG. 25. The total concentration of dmg is given for the plot with added dmg.

| | no add dmg | | | added dmg | | | |
|---|---|---|---|---|---|---|---|
| time (h) | TON/PS | TON/Cat | TON/dmg | [dmg] (M) | TON/PS | TON/Cat | TON/dmg |
| 0 | 0 | 0 | 0 | 2.98E−06 | 0 | 0 | 0.0 |
| 0.25 | 466 | 6 | 3 | 7.28E−06 | 536 | 7 | 1.5 |
| 0.5 | 1130 | 15 | 8 | 1.16E−05 | 1044 | 14 | 1.8 |
| 0.75 | 1774 | 24 | 12 | 1.59E−05 | 1532 | 21 | 1.9 |
| 1 | 2292 | 31 | 15 | 2.02E−05 | 2086 | 28 | 2.1 |
| 1.25 | 2847 | 38 | 19 | 2.02E−05 | 2591 | 35 | 2.6 |
| 1.5 | 2897 | 39 | 20 | 2.45E−05 | 2926 | 40 | 2.4 |
| 1.75 | 3032 | 41 | 21 | 2.88E−05 | 3242 | 44 | 2.3 |
| 3.5 | 3738 | 51 | 25 | 3.31E−05 | 5918 | 80 | 3.6 |
| 4 | 3746 | 51 | 25 | 3.74E−05 | 6508 | 88 | 3.5 |
| 4.5 | 3729 | 50 | 25 | 4.17E−05 | 6980 | 94 | 3.4 |
| 5 | 3737 | 51 | 25 | 4.60E−05 | 7199 | 97 | 3.1 |
| 6 | 3737 | 51 | 25 | 5.03E−05 | 7435 | 101 | 3.0 |
| 7 | 3737 | 51 | 25 | 5.46E−05 | 7527 | 102 | 2.8 |
| 23 | 3737 | 51 | 25 | 5.90E−05 | 9330 | 126 | 3.2 |
| 24 | 3737 | 51 | 25 | 6.33E−05 | 9384 | 127 | 3.0 |

### EXAMPLE 3

### Example of Hydrogen Generation Using Heterogeneous Catalyst and Chalcogenoxanthylium Compound

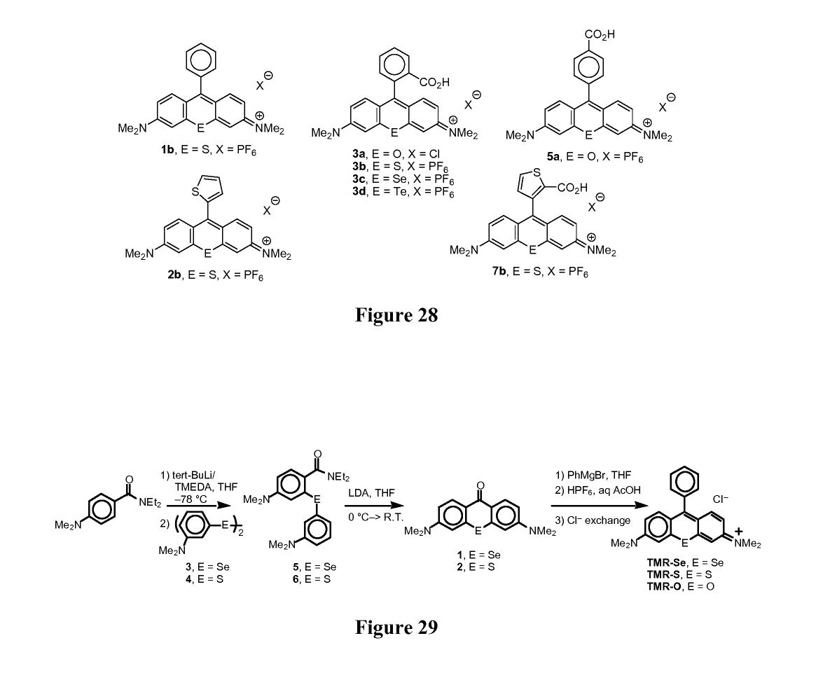

The following photosensitizers (FIG. 28) were used to generate hydrogen via irradiation of suspensions of 1) colloidal palladium or colloidal platinum or 2) platinum on titania (Pt/TiO₂) or platinum on zirconia (Pt/ZrO₂) in 3:1 acetonitrile/water irradiating with 520-nm light emitting diodes. All experiments utilized 0.025 mg of metal in 2 mL of solvent. The concentration of photosensitizer was 4.0×10⁻⁵ M with 1×10⁻³ triethanolamine (TEOA) added as a sacrificial electron donor. Colloidal platinum and palladium were prepared by sodium borohydride reduction of H₂PtCl₄ and Na₂PdCl₄.

The production of hydrogen by these combinations is reported in Table 6 for colloidal platinum and palladium and in Table 2 for platinized TiO₂ and platinized ZrO₂. Hydrogen evolution is expressed as the number of moles of hydrogen produced per mole of photosensitizer per hour of irradiation. Values are the average of duplicate runs.

TABLE 6
Hydrogen evolution with chalcogenorhodamine photosensitizers and
colloidal platinum or palladium in 3:1 acetontirile/water. Values are the
average of duplicate runs.

| | | Turnover Number per hour |
|---|---|---|
| | | (TON), |
| | | Mole H₂/mole |
| Photosensitizer | Catalyst | photosensitizer |
| none | Colloidal Platinum | 0 |
| 1b | Colloidal Platinum | 92 ± 15 |
| 3a | Colloidal Platinum | 91 ± 15 |
| 3b | Colloidal Platinum | 98 ± 10 |
| 3c | Colloidal Platinum | 1350 ± 50 |
| 7b | Colloidal Platinum | 143 ± 15 |
| none | Colloidal Palladium | 0 |
| 1b | Colloidal Palladium | 8 ± 4 |
| 3a | Colloidal Palladium | 64 ± 10 |
| 3b | Colloidal Palladium | 132 ± 8 |
| 3c | Colloidal Palladium | 62 ± 8 |
| 7b | Colloidal Palladium | 30 ± 8 |

TABLE 7
Hydrogen evolution with chalcogenorhodamine photosensitizers and
platinum on titania (Pt/TiO₂) or platinum on zirconia (Pt/ZrO₂) in 3:1
acetontirile/water. Values are the average of duplicate runs.

| | | Turnover Number per hour (TON), |
|---|---|---|
| Photosensitizer | Catalyst | Mole H₂/mole photosensitizer |
| none | Pt/TiO₂ | 0 |
| 1b | Pt/TiO₂ | 46 ± 8 |
| 2b | Pt/TiO₂ | 34 ± 4 |
| 3a | Pt/TiO₂ | 257 ± 15 |
| 3b | Pt/TiO₂ | 100 ± 10 |
| 3c | Pt/TiO₂ | 134 ± 5 |
| 3d | Pt/TiO₂ | 10 ± 5 |
| 5a | Pt/TiO₂ | 261 ± 10 |
| 7b | Pt/TiO₂ | 68 ± 8 |
| none | Pt/ZrO₂ | 0 |
| 1b | Pt/ZrO₂ | 7 ± 3 |
| 7b | Pt/ZrO₂ | 26 ± 8 |

While the invention has been particularly shown and described with reference to specific embodiments (some of which are preferred embodiments), it should be understood by those having skill in the art that various changes in form and detail may be made therein without departing from the spirit and scope of the present invention as disclosed herein.

What is claimed is:

1) A method for generating hydrogen comprising the steps of:
a) providing an aqueous solution comprising a catalyst, a sacrificial electron donor and a compound having the structure of Formula I: 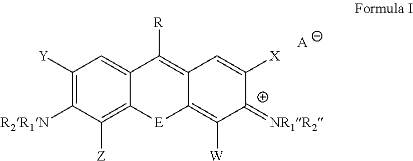
wherein E is O, S, Se or Te and A⁻ is an anionic group selected from the group consisting of halides, sulfonates; carboxylates; hexafluorophosphate, tetrafluoroborate and perchlorate; and
I)
i) W, X, Y, and Z are hydrogen;
ii) R₁′, R₂′, R₁″ and R₂″ are independently hydrogen or C₁ through C₈ branched or unbranched alkyl, and, optionally,
1) R₁′ and R₂′ are alkyl groups connected such that they comprise a 3-, 4-, 5-, 6- or 7-membered ring 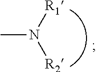
which, optionally, bears alkyl or aryl substituents;
and/or
2) R₁″ and R₂″ are alkyl groups connected such that they comprise a 3-, 4-, 5-, 6- or 7-membered ring 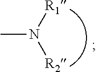
which, optionally, bears alkyl or aryl substituents;
iii) R is hydrogen or a C₁ through C₈ alkyl, aryl, heteroaryl, substituted aryl or substituted heteroaryl group;
or, 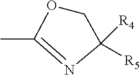
wherein R₄ and R₅ are C₁ through C₈ alkyl groups;
or
II)
i) W, X, Y and Z are independently hydrogen or C₁ through C₈ alkyl;
ii) R₁′, R₂′, R₁″ and R₂″ are independently hydrogen or C₁ through C₈ alkyl, and wherein, optionally,
R₁′ and Y are connected such that they comprise a five, six or seven-membered ring 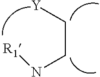
and/or R₂′ and Z are connected such that they comprise a five-, six- or seven-membered ring 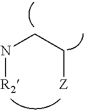
and/or R₁″ and W are connected such that they comprise a five-, six- or seven-membered ring 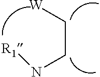
and/or R₂″ and X are connected such that they comprise a five-, six- or seven-membered ring: 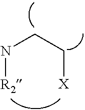
and
iii) R is a C₁ through C₈ alkyl, aryl, substituted aryl, heterocyclic or substituted heterocyclic group; and
b) exposing the solution from step a) to electromagnetic radiation having a wavelength of from 400 nm to 850 nm,
such that hydrogen is generated.

2) The method of claim 1, wherein the aqueous solution has from 10 mol % to 100 mol % water.

3) The method of claim 1, wherein the aqueous solution comprises a miscible solvent.

4) The method of claim 1, wherein the compound has the following structure: 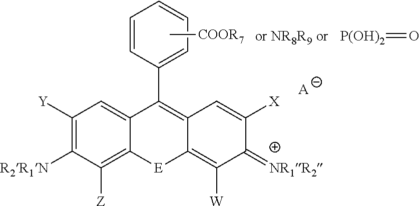
wherein R₇, R₈ and R₉ are each, independently, H or an alkyl group having 1 carbon to 8 carbons.

5) The method of claim 1, wherein the compound has the following structure: 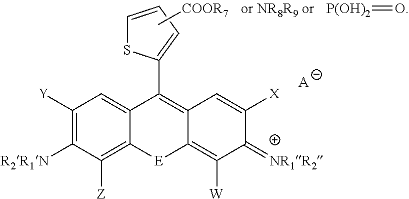
wherein R₇, R₈ and R₉ are each, independently, H or an alkyl group having 1 carbon to 8 carbons.

6) The method of claim 1, wherein the compound has the following structure: 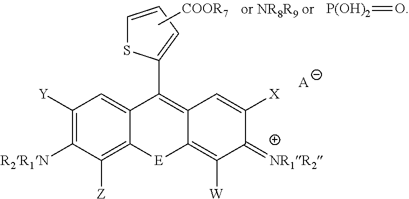
wherein R₇, R₈ and R₉ are each, independently, H or an alkyl group having 1 carbon to 8 carbons. 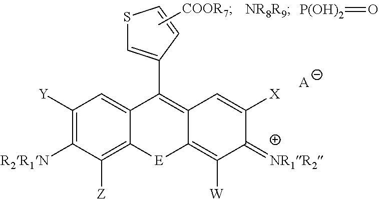
wherein R₇, R₈ and R₉ are each, independently, H or an alkyl group having 1 carbon to 8 carbons.

7) The method of claim 1, wherein the catalyst is a homogeneous catalyst and is Co(dmgH)₂Cl(py).

8) The method of claim 1, wherein the catalyst is a heterogeneous catalyst selected from colloidal platinum, colloidal palladium, platinized titania, platinized zirconia, and combinations thereof.

9) The method of claim 1, wherein the electromagnetic radiation has a wavelength of from 500 nm to 750 nm.

10) The method of claim 1, wherein the source of the electromagnetic radiation is selected from a mercury xenon lamp, a light emitting diode, a laser and sunlight.

11) The method of claim 1, wherein the temperature of the aqueous solution is from 0 to 100 degrees Celsius.

12) The method of claim 1, wherein the concentration of the photosensitizer is from 10⁻⁶ M to 10⁻³ M when a homogeneous catalyst is used

13) The method of claim 1, wherein the amount of photosensitizer used is from 10⁻⁹ mole/cm² of heterogeneous catalyst to 10⁻⁵ mole/cm² of heterogeneous catalyst, when a heterogeneous catalyst is used.

14) The method of claim 1, wherein the concentration of sacrificial electron donor is from 10⁻³ M to 1 M

15) The method of claim 1, wherein the concentration of homogeneous catalyst is from 10⁻⁵ M to 10⁻² M

16) The method of claim 1, wherein the heterogeneous catalyst is semiconducting metal oxide nanoparticles, wherein the particles have a metal or metal alloy deposited on the surface of the particles.

17) The method of claim 16, wherein the semiconducting metal oxide nanoparticles are titania or zirconia and the metal is platinum, and wherein the nanoparticles have from 0.02 to 2 wt-% metal.

18) The method of claim 1, wherein the heterogeneous catalyst is a colloidal metal selected from palladium or platinum, and wherein the amount of catalyst is from 0.001 mg/mL to 0.1 mg/mL.

19) The method of claim 1, wherein the pH of the aqueous solution from 2 to 10.
